(19) United States
(12) Patent Application Publication
(10) Pub. No.: US 2016/0253322 A1
(43) Pub. Date: Sep. 1, 2016

(54) METHOD AND APPARATUS FOR DATA STORAGE AND RETRIEVAL

(71) Applicant: TELEFONAKTIEBOLAGET L M ERICSSON (PUBL), Stockholm (SE)

(72) Inventor: Qingsong Li, Nanjing (CN)

(21) Appl. No.: 15/028,554

(22) PCT Filed: Oct. 18, 2013
(86) PCT No.: PCT/CN2013/085432

§ 371 Date: Apr. 11, 2016

(51) Int. Cl. G06F 17/30

(52) U.S. Cl. CPC G06F 17/3033

(57) ABSTRACT

Methods and apparatuses for data storage and retrieval have been provided. More specifically, a hash table is provided. The hash table comprises a first level slot array with a constant number of slots and at least one second level slot array with a variant number of slots. Each slot of the first level slot array is associated with a hash code range, and each slot of the first level slot array is linked to at most one second level slot array. Various operations, such as PUT, GET, RANGE_SEARCH of the hash table have been described. Moreover, a hash method has been provided for network management information to use the proposed hash table.

### TECHNICAL FIELD

Embodiments herein generally relate to data storage and retrieval, and more particularly to methods, apparatuses, and computer readable storage media for data storage and retrieval in a hash table.

### BACKGROUND

This section introduces aspects that may facilitate a better understanding of the disclosure. Accordingly, the statements of this section are to be read in this light and are not to be understood as admissions about what is in the prior art or what is not in the prior art.

In computer science, a hash table, also known as a hash map, is a basic data structure that can map keys to values. The idea of hashing is to distribute entries (key/value pairs) across an array of buckets or slots. A hash table uses a hash function to map a key to an index into the array of buckets or slots, from which the correct value corresponding to the key can be found.

A hash function may be provided by a hash table itself or a hash table may use a customized hash function associated with the type of keys. The major purpose of such a hash function is to compute a hash code from a given key, and the generated hash code is a number, normally a 32 bits integer. This computation can be expressed as: hash=hashfunc(key).

With the generated hash code for a given key, the hash table could compute an index into the bucket or slot array, which is a modulus operation against the size of the slot array in general. This computation can be expressed as: index=hash % array_size. The value corresponding to the key is then put into the index position of the slot array.

A critical statistic for a hash table is called the load factor. This is simply the number of stored entries divided by the number of slots, that is, n/k where n is the number of stored entries and k is the number of slots.

To keep the load factor under a certain limit, e.g. under 3/4 or 4/5, many table implementations expand the table when entries are inserted. This is called rehash or resizing. To limit the proportion of memory wasted due to empty buckets, some implementations also shrink the size of the table—followed by a rehash—when entries are deleted.

A common approach for resizing or rehash is to automatically trigger a complete resizing when the load factor exceeds some threshold rₘₐₓ. Then a new array of slots with increased length is allocated, all the entries of the original slot array are relocated to this new array one by one, and the original slot array is returned to the free storage pool. The relocation operation re-computes the index for each key-value pair against the length of the new slot array, and copies the value from the original slot array to the new index position in the new slot array. Likewise, when the load factor falls below a second threshold rₘᵢₙ, all entries are moved to a new smaller table.

In many situations, hash tables turn out to be more efficient than search trees or any other table lookup structure. For this reason, they are widely used in many kinds of computer software, particularly for associative arrays, database indexing, caches, and sets. However, an ordinary hash table has two disadvantages.

The first disadvantage is that it does not preserve the order of hash codes of stored items when storing items into the indexed slots. Specifically, during the index computation operation, the hash code order is not maintained any more in the index order. For instance, two entries with hash codes 9 and 13 respectively may have index positions 4 and 3 accordingly if the length of the slot array is 5. This works fine if keys are not relevant, and hence there is no need to maintain such order in index positions. However, for a case where keys are relevant and the hash code order is actually same as the key order, this behaviour then results that the hash table is not able to preserve the order of keys, and it in turn limits the ability to do a range search (also known as a range query, a proportional search, a sequential search, etc.) in the hash table. As the name implies, a range search means performing a search in a specific range within the whole search space.

For example, for a hash table storing scientific terms, each term starts with one of letters ‘A’ to ‘Z’, and the hash codes for all terms are in order of the first letter. Due to the above limitation, that is, the order of the first letter is not preserved when storing these terms into the index positions of the slot array, it is impossible to do a range search from the hash table to find all terms starts with ‘B’, as an example. Instead a full hash table scan is needed.

The second disadvantage is that resizing or rehash of the ordinary hash table is a central processing unit (CPU) heavy task as the amount of required reallocation entries is very large and also indeterminable. Resizing or rehash will make operations using the hash table have long and indeterminable response time, which is not acceptable for real time systems.

U.S. Pat. No. 8,423,594 B2 “REAL-TIME HASH MAP” has disclosed a method for implementing a hash map to improve performance consistency. The method includes providing a hash map comprising a set of tables, the set of tables initially containing a first table. When the first table is full, the method augments the hash map by adding a second table to the set of tables.

A hash table can be used to store all kinds of information, such as network management information. A network management system for a radio access network or other telecom networks like Internet Protocol (IP) transport network normally follows the International Telecommunication Union-Telecommunication (ITU-T) Telecommunication Management Network (TMN) recommendations as well as the 3^{rd} Generation Partnership Project (3GPP) telecommunication management standards. In such a Manager-Agent model based network management system with a hierarchical architecture, there may be a unified network management system on the top level, which manages one or more sub-network management systems, that may be called Domain Manager (DM). Each Domain Manager usually manages one or more Managed Elements (also called management node). A Managed Element represents one or more network nodes which could be managed.

Network management activities in the above network management system are usually referred to as Operations, Administration, Maintenance, and Provisioning (OAM&P). During such activities, one or more Managed Objects (MOs) are usually involved. A Managed Object in general is an abstraction of physical or logical resource to be managed. The definition of a Managed Object, which is normally called Managed Object Class (MOC), is pre-known between different levels of the network management system. Each level of the network management system could maintain a database of Managed Objects, which is called Managed Information Base (MIB).

A management node manages a set of Managed Objects which are from different types of MOCs. Such different MOCs constitute a Management Information Model (MIM) in the management node's context. The MIM contains an MOC tree hierarchy and cardinal numbers for each MOC. A cardinal number, or cardinal for short, is a generalization of the natural numbers used to measure the cardinality or size of sets. The cardinality of a finite set is a natural number—the number of elements in the set. In the context herein, a cardinal number of an MOC means the maximal number of instances (i.e., MOs) of the MOC under each parent MO of a parent MOC, i.e., the maximal number of MOs belonging to the MOC under each parent MO belonging to a parent MOC.

3GPP TS 32.300 has defined name convention for Managed Objects. Names in name space are organised in hierarchy. An MO instance that contains another one is referred to as the superior (parent), whereas the contained MO instance is referred to as the subordinate (child). In modern network management, it is expected that the Enterprise name space be partitioned for implementations in multiple managed system. The parent of all MO instances in a single managed system is called the Local Root. The ultimate parent of all MO instances of all managed systems is called the Global Root. Such a name defined in the TS 32.300 is often referred to as a relative distinguished name, a local distinguished name, or simply a distinguished name. An example of such a distinguished name (DN) is listed as below:

### “SubNetwork=ABCNetwork,SubNetwork=TN2,MSCFunction=B5C0100,

Log=19990101131000, AccountingRecord=100098”

This DN represents an MO “100098” with MOC “AccountingRecord”, where the MO is contained under other two ancestor MOs “Log=19990101131000” and “MSCFunction=B5C0100”. This DN also contains a global root “SubNetwork=ABCNetwork, SubNetwork=TN2”, which enables the MO to be uniquely identified in the whole network.

The data of MOs need to be retrieved from managed elements or different levels of network management systems during daily operations, to network administrators with a graphic user interface (GUI), or to other network management systems for OAM&P purposes, such as data synchronization. Such retrieval requests could be listed with below retrieval categories:

Type 1: Retrieve a single MO's data by providing the MO's distinguished name (DN);

Type 2: Retrieve a set of MOs' data of a same MOC by providing the MOC's name; and

Type 3: Retrieve a set of MOs' data of one or more MOCs, these MOs are all descendants from a same MO; by providing the MO's DN and the names of the one or more MOCs.

A management system needs to support all the three types of retrieval requests. There are other types of retrieval requests as well, for instance “full MIB sync”, but they could be seen as variants of the above three types.

To support fast response to the above retrieval requests in a management system or managed element, an in-memory cache is often used to pre-cache all MOs' data in its management context. The retrieval result is scanned from the cache rather than querying from the MIB database in order to obtain better performance. Such an in-memory cache consists of one or more data structures storing MO data as well as one or more corresponding algorithms for retrieval purpose and for maintaining consistency with MIB, for examples MO creation, MO deletion or MO re-parenting.

A straightforward way for such cache function is to implement a hash table storing all MOs' data, with MO's DN as the key. It works perfectly for the 1st type of retrieval requests with O(1) time complexity to return result. However, for the 2nd and 3rd types of retrieval requests, the whole hash table needs to be scanned to return result, and the time complexity becomes O(n) then.

In order to overcome this issue, in an existing solution, an additional tree data structure may be implemented to contain the whole MOs' hierarchy. Each tree node represents an MO and consists of the MO's data and all its child MOs' tree nodes. Meanwhile the hash entries in the hash table contain pointers to tree nodes of corresponding MOs rather than storing the MO data directly. In this solution, the 1^{st} and 3^{rd} types of requests have O(1) time complexity, and the 2^{nd} type of request still needs to traverse the tree from the root node to the bottom nodes which is O(n) time complexity. Please be noted that, the 3^{rd} type request having O(1) time complexity only applies for direct child MO search. To keep it simple, in the context of this application, the 3^{rd} request is referred always to its direct child search.

As can be seen, based on the existing hash table, the above management information lookup algorithms have following disadvantages:

In the case of the only hash table solution, it's very easy to implement and less effort needed to maintain the consistency between the hash table and the MIB, but its time complexity is linear (O(n)) for the 2^{nd} and 3^{rd} types of requests.

In the case of the tree and hash table combination solution, the performance for 1^{st} and 3^{rd} requests is good, but the 2^{nd} type request is still of O(n) time complexity and it has also to maintain consistency for both the tree structure and the hash table with the MIB.

In addition, the memory consumption is increased for the combination solution, and each MO has at least two references and associated relationship memory allocation.

### SUMMARY

To address one or more of the above concerns, it would be desirable in the art to provide a new data structure. Further, it would be desirable to provide an efficient and high performance search method to support all the three types of retrieval requests.

In a first aspect, a method for processing data in a hash table is provided. The hash table comprises a first level slot array with a constant number of slots and at least one second level slot array with a variant number of slots. Each slot of the first level slot array is associated with a hash code range generated with a first hash function, and each slot of the first level slot array is linked to at most one second level slot array. The method comprises: receiving data to be processed, the data being represented by a key and value pair; obtaining a first hash code which is generated from the key according to the first hash function; determining a slot of the first level slot array associated with a hash code range to which the first hash code corresponds; and storing the key and value pair into a second level slot array to which the determined slot of the first level slot array is linked.

In some embodiments, the constant number N of slots of the first level slot array may be determined based on a maximum possible number of key and value pairs to be put into the hash table and a space factor for the first level slot array.

In some further embodiments, the slots of the first level slot array may be arranged to be associated with a respective hash code range in the order of hash codes generated according to the first hash function.

In some embodiments, storing the key and value pair into a second level slot array may comprise: deciding whether the second level slot array needs resizing; resizing the second level slot array in response that the second level slot array needs resizing; determining a slot of the second level slot array or of the resized second level slot array from the key according to a second hash function; and storing the key and value pair into the determined slot of the second level slot array or of the resized second level slot array as a hash entry.

In some embodiments, the data may include network management information consisted of a set of managed objects. A managed object belongs to a managed object class, MOC. A set of MOCs may be represented by an MOC tree based on parent-child inheritance relationships among the MOCs. The managed object's distinguished name may be used as a key, and the managed object's data is a value associated with the key. Moreover, the first hash function may be arranged to map a distinguished name of a managed object to a first hash code, preserving an order where a hash code of any MO belonging to any MOC is larger than a hash code of any MO belonging to any parent MOC of the MOC, or a hash code of any MO belonging to any MOC is smaller than a hash code of any MO belonging to any parent MOC of the MOC.

In further embodiments, the hash table may be initialized by: traversing the MOC tree in an order that, for any MOC node, its ancestor MOC nodes are traversed prior to it; for each traversed MOC node, allocating a code range based on a cardinal number of the MOC node and cardinal numbers of its all ancestor MOC nodes till a root node; and dividing a space consisted of the code ranges into hash code ranges with which the slots of the first level slot array are associated.

In further embodiments, the first hash function may be arranged to map a distinguished name of a managed object to a first hash code by: parsing the managed object's distinguished name into a set of relative distinguished names, RDNs; for each RDN, determining a relative position i(RDN) of the RDN within an allocated code range of a MOC node to which the RDN belongs; and generating the first hash code based on the relative position of each RDN.

In a second aspect, a method for retrieving data from a hash table is provided. The hash table comprises a first level slot array with a constant number of slots and at least one second level slot array with a variant number of slots. Each slot of the first level slot array is associated with a hash code range generated with a first hash function, and each slot of the first level slot array is linked to at most one second level slot array. The data represented by key and value pairs are stored as hash entries in the hash table. The method comprises: receiving a key; obtaining a first hash code which is generated from the key according to the first hash function; determining a slot of the first level slot array associated with a hash code range to which the first hash code corresponds; and retrieving a value corresponding to the key from a second level slot array to which the determined slot of the first level slot array is linked.

In a third aspect, a method for searching data in a range of a hash table is provided. The hash table comprises a first level slot array with a constant number of slots and at least one second level slot array with a variant number of slots. Each slot of the first level slot array is associated with a hash code range in the order of hash codes generated with a first hash function, and each slot of the first level slot array is linked to at most one second level slot array. The data represented by key and value pairs are stored as hash entries in the hash table. The method comprises: obtaining a start hash code and an end hash code which define the range of the hash table; determining a slot range of the first level slot array, where a start slot of the slot range is associated with a hash code range to which the start hash code corresponds, and an end slot of the slot range is associated with a hash code range to which the end hash code corresponds; searching hash entries in each second level slot array to which each slot within the slot range is linked; and returning searched hash entries.

In some embodiments, obtaining a start hash code and an end hash code may comprise: receiving a start key and an end key; and generating the start hash code from the start key according to the first hash function and the end hash code from the end key according to the first hash function.

In some embodiments, the data may include network management information consisted of a set of managed objects. A managed object belongs to a managed object class, MOC. A set of MOCs may be represented by an MOC tree based on parent-child inheritance relationships among the MOCs. The managed object's distinguished name may be used as a key, and the managed object's data is a value associated with the key. Moreover, the first hash function may be arranged to map a distinguished name of a managed object to a first hash code, preserving an order where a hash code of any MO belonging to any MOC is larger than a hash code of any MO belonging to any parent MOC of the MOC, or a hash code of any MO belonging to any MOC is smaller than a hash code of any MO belonging to any parent MOC of the MOC.

In further embodiments, the hash table may be initialized by: traversing the MOC tree in an order that, for any MOC node, its ancestor MOC nodes are traversed prior to it; for each traversed MOC node, allocating a code range based on a cardinal number of the MOC node and cardinal numbers of its all ancestor MOC nodes till a root node; and dividing a space consisted of the code ranges into hash code ranges with which the slots of the first level slot array are associated.

In some embodiments, obtaining a start hash code and an end hash code may comprise: receiving a retrieval request for retrieving data of a set of managed objects belonging to a given MOC, the retrieval request containing the given MOC's name; searching the MOC tree for the given MOC to obtain its allocated code range; and determining the start hash code as the start of the allocated code range, and the end hash code as the end of the allocated code range.

In some other embodiments, obtaining a start hash code and an end hash code may comprise: receiving a retrieval request for retrieving data of a set of managed objects belonging to one or more MOC, the managed objects of the set of managed objects being descendants from a given managed object, the retrieval request containing the given managed object's distinguished name and a set of MOC names which are descendents of the given managed object's MOC; and for each descendent MOC, searching the MOC tree for the descendent MOC to obtain its allocated code range; extracting a hash code range corresponding to descendents of the given managed object from the allocated code range, based on a first hash code generated from the given managed object's distinguished name according to the first hash function; and determining the start hash code as the start of the extracted hash code range, and the end hash code as the end of the extracted hash code range.

In some embodiments, the method may further comprise: obtaining a filter condition; and filtering the searched hash entries with the filter condition.

In a fourth aspect, an apparatus for processing data in a hash table is provided. The hash table comprises a first level slot array with a constant number of slots and at least one second level slot array with a variant number of slots. Each slot of the first level slot array is associated with a hash code range generated with a first hash function, and each slot of the first level slot array is linked to at most one second level slot array. The apparatus comprises: a receiving unit, configured to receive data to be processed, the data being represented by a key and value pair; a first level unit, comprising a first hashing unit configured to obtain a first hash code which is generated from the key according to the first hash function, and a first slot determination unit configured to determine a slot of the first level slot array associated with a hash code range to which the first hash code corresponds; and a second level unit, configured to store the key and value pair into a second level slot array to which the determined slot of the first level slot array is linked.

In a fifth aspect, an apparatus for searching data in a range of a hash table is provided. The hash table comprises a first level slot array with a constant number of slots and at least one second level slot array with a variant number of slots. Each slot of the first level slot array is associated with a hash code range generated with a first hash function, and each slot of the first level slot array is linked to at most one second level slot array. The data represented by key and value pairs are stored as hash entries in the hash table. The apparatus comprises: a parameter obtaining unit, configured to obtain a start hash code and an end hash code which define the range of the hash table; a range determination unit, configured to determine a slot range of the first level slot array, where a start slot of the slot range is associated with a hash code range to which the start hash code corresponds, and an end slot of the slot range is associated with a hash code range to which the end hash code corresponds; a searching unit, configured to search hash entries in each second level slot array to which each slot within the slot range is linked; and a result output unit, configured to return searched hash entries.

In a sixth aspect, an apparatus for processing data in a hash table is provided. The hash table comprises a first level slot array with a constant number of slots and at least one second level slot array with a variant number of slots. Each slot of the first level slot array is associated with a hash code range in the order of hash codes generated with a first hash function, and each slot of the first level slot array is linked to at most one second level slot array. The apparatus comprises: at least one processor; and at least one memory, the at least one memory containing instructions executable by the at least one processor, whereby the apparatus is operative to perform methods according to the first, the second, or the third aspect as above described.

In a seventh aspect, a non-transitory computer-readable storage media having computer program code stored thereon is provided. The computer program code is configured to, when executed, cause an apparatus to perform actions in the method according to the first, the second, or the third aspect as above described.

With particular embodiments of the techniques described in this specification, by using two levels slot arrays, resizing/rehashing of the hash table can be performed gradually, which consumes much fewer CPU each time the hash table is resized, and thus can be applied in real time systems. In some further embodiments, by associating each slot of the first slot array with a hash code range in the order of hash codes generated with the first hash function, range searches can be supported. On the other hand, the management information retrieval using the proposed hash table can well support all three types of retrieval requests with high performance.

Other features and advantages of the embodiments herein will also be understood from the following description of specific embodiments when read in conjunction with the accompanying drawings, which illustrate, by way of example, the principles of embodiments.

### BRIEF DESCRIPTION OF THE DRAWINGS

The above and other aspects, features, and benefits of various embodiments herein will become more fully apparent, by way of example, from the following detailed description and the accompanying drawings, in which:

FIG. 1 illustrates an exemplary structure of a hash table according to embodiments herein;

FIG. 2 illustrates a flowchart of a PUT operation of a hash table according to embodiments of the present disclosure;

FIG. 3 illustrates a flowchart of putting the key and value pair into the second level slot array according to embodiments of the present disclosure;

FIG. 4 illustrates a flowchart of a GET operation of a hash table according to embodiments of the present disclosure;

FIG. 5 illustrates a flowchart of GET operation in a second level slot array according to embodiments of the present disclosure;

FIG. 6 illustrates a flowchart of RANGE_SEARCH operation of a hash table according to embodiments of the present disclosure;

FIG. 7 illustrates an exemplary initialization procedure according to embodiments of the present disclosure;

FIG. 8 illustrates an example of an MIM data;

FIG. 9 illustrates an example implementation of an MOC tree node;

FIG. 10 illustrates an exemplary MOC tree structure according to embodiments herein;

FIG. 11 illustrates an exemplary procedure for traversing the MOC tree and allocating code ranges according to embodiments herein;

FIG. 12 illustrates the dividing of the code space according to embodiments herein;

FIG. 13 illustrates an exemplary set of Managed Objects according to embodiments herein;

FIG. 14 illustrates an exemplary hash procedure according to embodiments herein;

FIG. 15 illustrates an exemplary procedure for computing an index i(RDN) for each RDN in the distinguished name;

FIG. 16 illustrates the code space of the MOC tree as shown in FIG. 10 in more detail;

FIG. 17 illustrates a flowchart of RETRIEVE procedure of the network management information by using the constant hash table according to embodiments herein;

FIG. 18 illustrates a general system where embodiments of the present disclosure may be implemented;

FIG. 19 illustrates a schematic block diagram of an apparatus that may be configured to implement the constant hash table module 1810 as shown in FIG. 18;

FIG. 20 illustrates a schematic block diagram of an apparatus that may be configured to implement the hash function module 1830 as shown in FIG. 18;

FIG. 21 illustrates a schematic block diagram of an apparatus that may be configured to implement the search module 1840 as shown in FIG. 18;

FIG. 22 illustrates an example implementation 2200 of the parameter obtaining unit 2110 as shown in FIG. 21 for handling the second type of retrieval request;

FIG. 23 illustrates another example implementation 2300 of the parameter obtaining unit 2110 as shown in FIG. 21 for handling the third type of retrieval request;

FIG. 24 shows an exemplary computer system 2400 which is applicable to implement the embodiments of the present disclosure; and

FIG. 25 schematically illustrates exemplary storage media, in which one or more embodiments of the present disclosure may be embodied.

### DETAILED DESCRIPTION

Hereinafter, the principle and spirit of the present disclosure will be described with reference to the illustrative embodiments. It should be understood, all these embodiments are given merely for the skilled in the art to better understand and further practice the present disclosure, but not for limiting the scope of the present disclosure. For example, features illustrated or described as part of one embodiment may be used with another embodiment to yield still a further embodiment. In the interest of clarity, not all features of an actual implementation are described in this specification.

### Hash Table

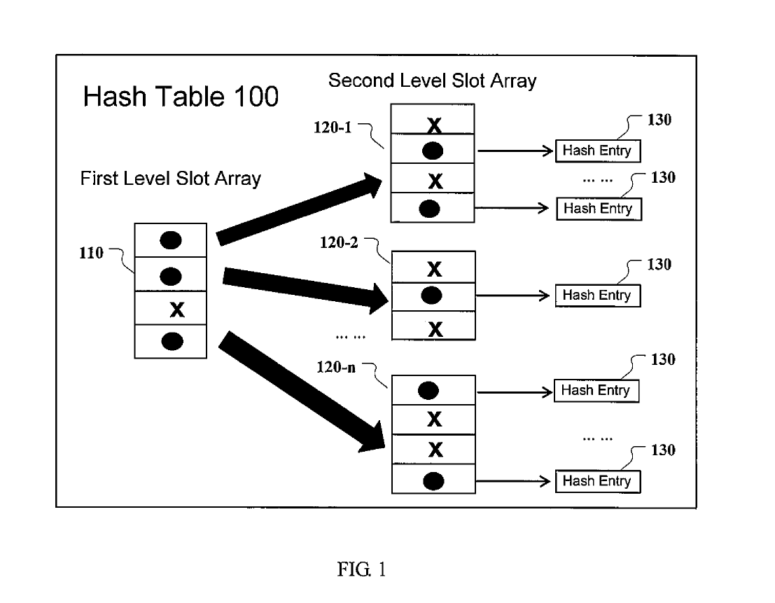

FIG. 1 illustrates an exemplary structure of a hash table 100 according to embodiments herein.

As shown in FIG. 1, the hash table 100 comprises a first level slot array 110 and at least one second level slot array 120-1, 120-2, . . . , 120-n. The first level slot array 110 has a constant number N of slots. Each slot of the first level slot array 110 is associated with a hash code range generated with a first hash function, so that each slot in the first level slot array 110 is associated with a fixed portion of all possible hash codes.

The second level slot arrays 120-1, 120-2, . . . , 120-n each have variant numbers of slots, as in conventional hash tables. A slot in the second level slot arrays may contain a pointer to the address of a hash entry 130. A hash entry is normally a linked list to store one or more key-value pairs. Data represented by key and value pairs can be stored as hash entries 130 in the hash table.

Each slot of the first level slot array 110 is linked to at most one second level slot array 120-1, 120-2, . . . , 120-n and may contain a pointer to a second level slot array. As shown in FIG. 1, some slots of the first level slot array 110 link to respective second level slot arrays, while some slots may simply link to nothing, because a hash entry has not yet been associated with these slots.

With the above two-level structure, for a certain key and value pair with a certain hash code, firstly a slot in the first level slot array 110 associated with a hash code range to which the hash code corresponds will be determined. Then, the key and value pair will be stored into a second level slot array 120-1, 120-2, . . . , 120-n to which the determined slot of the first level slot array 110 is linked. By using two levels slot arrays, each time the hash table is resized, only part of the hash table, i.e., a second level slot array needs to be resized, which consumes much fewer CPU and thus can be applied in real time systems. Since the first level slot array has a constant length, the proposed hash table may also be called “a constant hash table”.

Construction of the proposed hash table is described below. The constant length N (or slot numbers) of the first level slot array 110 can be determined based on a maximum possible number K of key-value pairs to be put into the hash table and a space factor S for the first level slot array 110. The length N can be expressed as:

N=ROUND(K*S) (1)

where ROUND( ) is a rounding to integer function.

The space factor S is a ratio of the volume occupied by the first level slot array to the total volume of possible hash entries, where 0<S<=1. Supposing that hash entries are distributed evenly on the slots of the first level slot array, the space factor S can also be understood as a coefficient indicating at most how many hash entries can be associated with a same slot of the first level slot array. For example, if S=0.5, then each slot of the first level slot array can be associated with at most two hash entries; and if S=0.1, then each slot can be associated with up to ten hash entries.

In some embodiments, the slots of the first level slot array may be arranged to be associated with a respective hash code range in the order of hash codes generated with the first hash function and used for the first level slot array. In other words, the respective hash code ranges associated with slots of the first level slot array have an order that is consistent with the order of the hash codes generated with the first hash function. The order of hash codes can be in an ascending order (i.e. from small to large) or in a descending order (i.e. from large to small). Such an ordered association can enable range search and facilitate and simplify the processing of data in the constant hash table. In embodiments described throughout the detailed description herein, unless otherwise specified, the ascending order is taken as an example for illustration. Those skilled in the art could appreciate that, similar methods can be derived for the descending order based on the exemplary embodiments disclosed herein.

Preferably, the hash code ranges are allocated evenly to the slots of the first level slot array. The density D of hash codes is defined as blow:

$$D = CEIL ( \frac{{h}_{max} - {h}_{min}}{N} ) \qquad ( 2 )$$

where hₘₐₓ is the maximal possible hash code used for the first level slot array for all keys, hₘᵢₙ is the minimal possible hash code used for the first level slot array for all keys, and CEIL( ) is a function to round a number UP to the nearest integer. From the equation (2), it can be understood that the density D indicates a span of each hash code range of the slots of the first level slot array, and N*D≧hₘₐₓ−hₘᵢₙ. For example, the hash code range [hₘᵢₙ, hₘᵢₙ, +D) is allocated to the first slot in the first level slot array, the hash code range [hₘᵢₙ+D, hₘᵢₙ+2D) is allocated to the second slot in the first level slot array, and so on. Those skilled in the art could understand that, ‘[a, b)’ means a range from a to b, including a but excluding b. In this way, each slot in the first level slot array will be associated with a fixed portion (defined with the density D) of all possible hash codes in the order of hash codes.

The skilled in the art could appreciate that, other allocation method may also be used to allocate a hash code range to a slot of the first level slot array. Provided that each slot of the first level slot array has a fixed hash code range in the order of hash codes, range searches can be performed in such a hash table due to partially preserving the order of hash codes.

In one implementation, the first level slot array and the at least one second level slot array may be located on a same computer. In this case, the slot of the first level slot array may contain a pointer to the memory address of a second level slot array. In another implementation, the first level slot array and the at least one second level slot array may be located on different computers, for example deployed in a distributed environment for distributed caching or task distribution purpose. In this case, the slot of the first level slot array may contain a network address and communication protocol of a second level slot array, for instance an IP address plus HTTP protocol, a processor address plus operating system signaling protocol, etc.

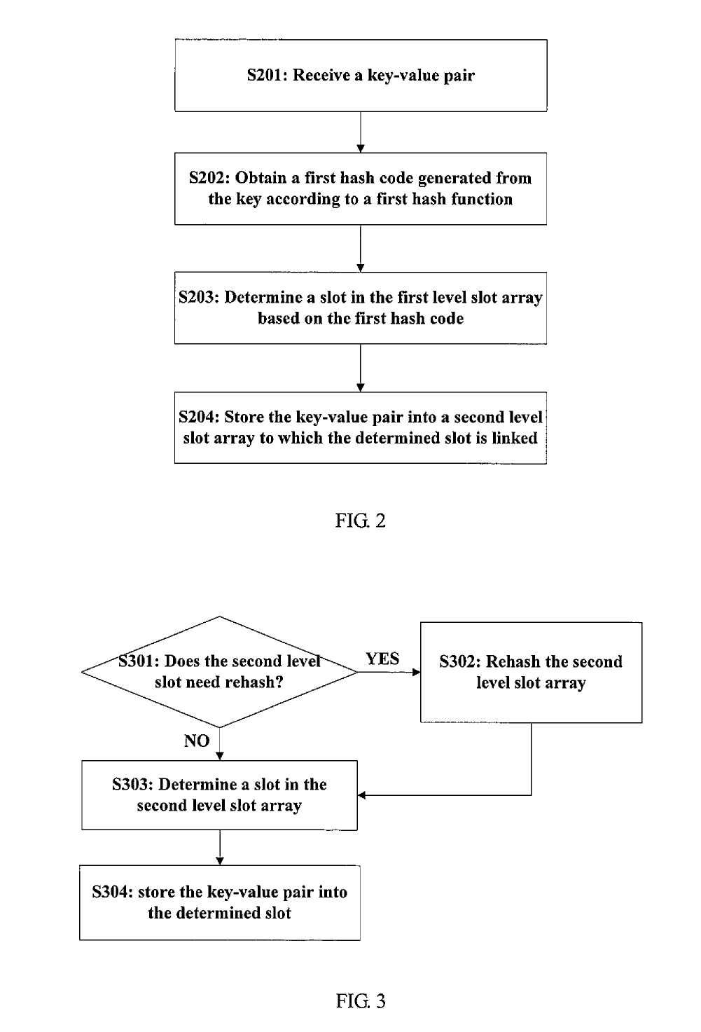

In the following, the operations of the proposed hash table will be described with reference to FIGS. 2-6. The proposed hash table may have a few operations, like PUT, GET, DELETE, and PROPORTION_SCAN (or RANGE_SEARCH).

FIG. 2 illustrates a flowchart of a PUT operation of a hash table according to embodiments of the present disclosure. The PUT operation is used to store a key-value pair into the hash table.

As shown in FIG. 2, at block S201, data to be processed or stored is received. The data is represented by a key and value pair. Generally, a key is a data structure from which a numeric value could be generated by a certain hash function, and a value is data associated with the key and to be put into the hash table.

Then, at block S202, a first hash code is obtained. The first hash code hₖ is generated from the key k according to the first hash function h(k). The first hash function h(k) may be preconfigured internally or may be provided by a user. In this regard, the first hash code can be generated outside and delivered to the hash table.

Having obtained the first hash code hₖ, at block S203, a slot in the first level slot array is determined based on the first hash code hₖ, thereby determining which second slot array to store this key and value pair. That is, a slot of the first level slot array which has a hash code range to which the first hash code hₖ corresponds is determined. In one implementation, the index of the slot can be determined by:

$$i ( {h}_{k} ) = FLOOR ( \frac{{h}_{k} - {h}_{min}}{D} ) \qquad ( 3 )$$

where FLOOR( ) is a function to round a number DOWN to the nearest integer.

After that, at block S204, the key and value pair is stored into a second level slot array to which the determined slot of the first level slot array is linked.

Then, the determined second level slot array continues to process the key and value pair. In some embodiments, a notification may be transferred to the second level slot array. In one implementation, such notification could be a method call from the first level slot array if the proposed hash table is deployed into a single computer resource. On the other hand, if the proposed hash table is deployed across several computer resources, such notification may be a message sent from the first level slot array to the corresponding computer of a second level slot array. The message contains the data of the key-value pair. The message could be but not limited to HTTP request, TCP socket message, or any kind of operating system signal.

Thereafter, the second level slot array could perform the operation of putting the key and value pair into a slot thereof, which is similar to that in the conventional hash table. FIG. 3 illustrates a flowchart of putting the key and value pair into the second level slot array according to embodiments of the present disclosure.

As shown in FIG. 3, when putting a key and value pair into a second level slot array, it is decided firstly whether the second level slot array needs resizing or rehash at block S301.

The decision may be based on the load factor, as described in the background. Specifically, the ratio of the number of existing entries in the second level slot array to the number of slots of the second level slot array is compared with a threshold for the load factor. If the ratio exceeds the threshold (e.g., 3/4), then this second level slot array needs resizing or rehash, and the operation goes to block S302.

At block S302, a common approach for resizing or rehash may be applied to the second level slot array. For example, a new array of slots with increased length is allocated, all the entries of the original slot array are relocated to this new array one by one, and the original slot array is returned to the free storage pool. The relocation operation re-computes the index for each key-value pair against the length of the new slot array, and copies the value from the original slot array to the new index position in the new slot array.

Having resized the second level slot array, the operation goes to block S303. Also, if it is decided that no resizing or rehash is needed at block S301, then the operation goes to block S303.

At block S303, a slot in the second level slot array or in the resized second level slot array may be determined for storing the key and value pair.

Similar to the conventional hash table, a second hash code can be determined firstly. The second hash code h′ₖ can be generated from the key according to a second hash function h′(k). In one implementation, the second hash function may be same as the first hash function. In such case, the second hash code h′ₖ is the first hash code hₖ, and there is no need to re-generate the hash code. In another implementation, the second hash function may be another internal hash function for generating the second hash code h′ₖ. For example, the second hash function may be:

$${h}^{′} ( k ) = {\sum }_{i = 0}^{n - 1} ( {k}_{i} * {p}^{n - i - 1} ) \qquad ( 4 )$$

where n is the length of the key in bytes, kᵢ is the i^{th} byte of the key, and P is a constant prime number e.g. 47.

With the second hash code h′ₖ, an index function may be used to determine the index of a slot of the second level slot array or the resized second level slot array to store the key and value pair. In one implementation, the index function may be a modulus operation against the size or length of the second level slot array or the resized second level slot array. That is, the slot index is decided by the arithmetical compliment value of the second hash code h′ₖ dividing the length of the second level slot array or the resized second level slot array.

Finally, at block S304, the key and value pair is stored into the decided position of the (resized) second level slot array as a hash entry.

From the above description, it can be seen that the proposed hash table only rehashes or resizes one second level slot array at one time, and therefore only part of elements in the proposed hash table needs to be relocated instead of all elements in the hash table as in the conventional case. Likewise, when deleting a hash entry from the hash table, it may be decided whether a second level slot array needs shrinking the size of the array, i.e., the load factor falls below a second threshold. If there is a need, the second level slot array is resized and all entries of the second level slot array are moved to a new smaller array. The DELETE operation is a reverse operation to the PUT operation, and thus the detail thereof is omitted herein.

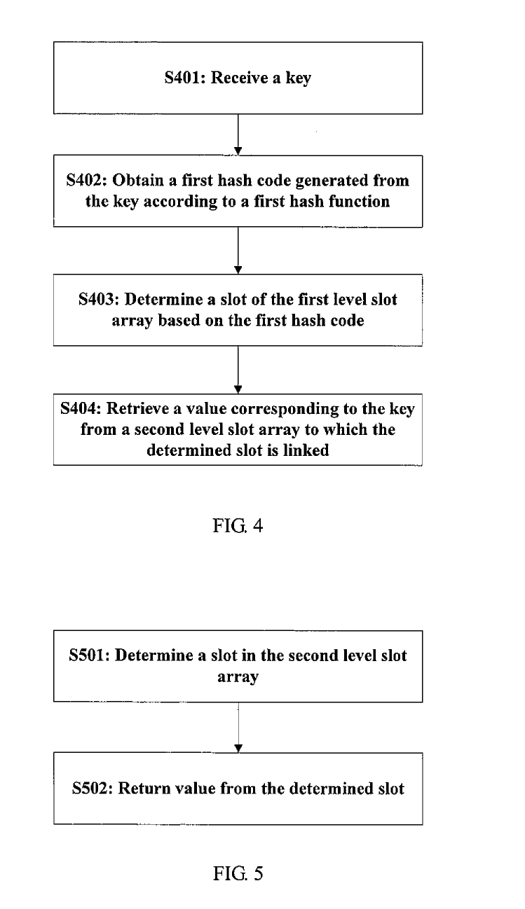

FIG. 4 illustrates a flowchart of a GET operation of a hash table according to embodiments of the present disclosure. The GET operation is used to retrieve a corresponding value from a hash table with a given key, and the value is previously stored with PUT operation.

As shown in FIG. 4, at block S401, only a key is received. The following blocks S402-S404 are same as the blocks S202-S204 in PUT operation.

Briefly, at block S402, a first hash code hₖ is obtained. The first hash code hₖ is generated from the key k according to the first hash function h(k). Then, at block S403, a slot of the first level slot array associated with a hash code range to which the first hash code hₖ corresponds is determined. Finally, at block S404, a value corresponding to the given key is retrieved from a second level slot array to which the determined slot of the first level slot array is linked.

FIG. 5 illustrates a flowchart of GET operation in a second level slot array according to embodiments of the present disclosure.

As shown in FIG. 5, at block S501, a slot in the second level slot array which stores the value corresponding to the given key is determined. The determination is same as the block S303 in PUT operation of FIG. 3. To be brief, a second hash code h′ₖ is obtained by a second hash function h′(k) which is the same as the one used in PUT operation. With the second hash code h′ₖ, an index function is used to determine the index of a slot of the second level slot array which has stored the value corresponding to the key. For example, the index function may be a modulus operation against the size or length of the second level slot array.

Finally, at block S502, all key-value pairs stored in the determined slot of the second level slot array are checked with the received key. If the key of a key-value pair is same as the received key, then the value of the key-value pair is returned. Otherwise, if none of the key-value pairs matches the received key, NULL is returned.

As mentioned previously, the proposed hash table also supports an operation of PROPORTION_SCAN or RANGE_SEARCH provided that each slot of the first level slot array is associated with a respective hash code range in the order of hash codes generated with the first hash function. This operation is used to search a range of the hash table. This operation scans only part of the hash table, instead of full scan in the conventional hash table.

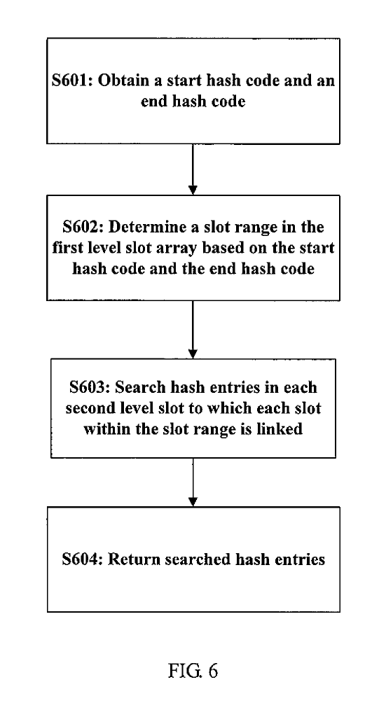

FIG. 6 illustrates a flowchart of RANGE_SEARCH operation of a hash table according to embodiments of the present disclosure.

At block S601, a start hash code hₛ and an end hash code hₑ are obtained, which are conditions used for range search and are used to define a range of the constant hash table. The start hash code and the end hash code contain a hash code range which is the limited scope used in the scan. Thus, at this block, it may also be checked whether hₛ is less than hₑ, i.e., hₛ≦hₑ. If not matched, an error will occur and nothing will be done in the operation.

In one implementation, the start hash code and the end hash code may be received directly. In another implementation, a start key and an end key may be received. Then, the first hash function h(k) may be used to generate the start hash code from the start key, and generate the end hash code from the end key.

At block S602, a slot range of the first level slot array is determined. A start slot of the slot range is associated with a hash code range to which the start hash code corresponds, and an end slot of the slot range is associated with a hash code range to which the end hash code corresponds. The start slot and the end slot can be determined by using the equation (3). Thus, the start slot and the end slot decides a range in the first level slot array.

In some embodiments, for each slot in the slot range, its linked second level slot array will be notified one by one. Depending on the deployment of the hash table, such notification can be a method call or a message (e.g., HTTP request, TCP socket message, etc.) from the first level slot array to the second level slot array.

Then, at block S603, searches are performed on the hash entries in each second level slot array to which each slot in the slot range is linked, i.e., all hash entries stored in the second level slot array are traversed. Such traversal may be a simple array traversal in a sequential order, or an iterator traversal with less memory consumption.

At block S604, the searched hash entries in these second level slot array are returned and thus the RANGE_SEARCH operation ends. Similarly, such result return may be a result returned by a method call in a signal computer environment, or a message sent from the second level slot array to the computer of the first level slot array in a distributed environment.

Additionally, at block S601, a filter condition or a filter function may be received. The filter condition or function may be provided by a user for filtering attributes of each hash entry in the searched range. The filtering may be performed either during traversing hash entries in each second level slot array in the slot range at block S603 or after returning the searched hash entries at block S604.

Thus the above has described an example of the structure of the proposed hash table and various operations thereof, including PUT, GET, and RANGE_SEARCH. As seen from the above description, the proposed hash table has several advantages over the ordinary hash table. First, as mentioned above, incremental resizing or rehash is possible in the proposed hash table. Due to the two levels slot arrays, each time rehash happens, only part of elements (i.e., elements in a second level slot array) are needed to be moved, which consumes much fewer CPU. Second, because each slot of the first level slot array in the proposed hash table is associated with a fixed hash code range in the order of hash codes, range searches are enabled in such a hash table, which has significant benefit over full scan in a hash table in terms of time complexity. Third, the proposed hash table has a same time complexity (O(1)) with the ordinary hash table for GET and PUT operations. Fourth, the proposed hash table is still compatible with an ordinary hash table if the length of the first level slot array is set to 1, and then it becomes an ordinary hash table.

As stated previously, a hash table can be implemented to store network management information to support fast response to all three retrieval requests. In the following, the corresponding lookup algorithms for retrieval purpose and other purpose based on the proposed hash table will be described.

### Management Information Lookup

In this part, a hash method is designed for the network management information, and a method for network management information lookup is provided by using the proposed hash table.

As described previously, each level of the network management system could maintain a database of Managed Objects, which is called Managed Information Base (MIB). A management node manages a set of Managed Objects which are from different types of managed object classes (MOCs). Such different MOCs constitute a Management Information Model (MIM) in the management node's context. In other words, the network management information is consisted of a set of managed objects (MOs). A managed object belongs to a managed object class (MOC). In other words, a managed object is an instance of its MOC. A set of MOCs may be represented by an MOC tree based on parent-child inheritance relationship among the MOCs. The MIM contains an MOC tree hierarchy and cardinal numbers (i.e., instances numbers) for each MOC.

The proposed hash table could be used to cache the MIB, where the manage object's distinguished name is used as a key, and the managed object's data is a value associated with the key.

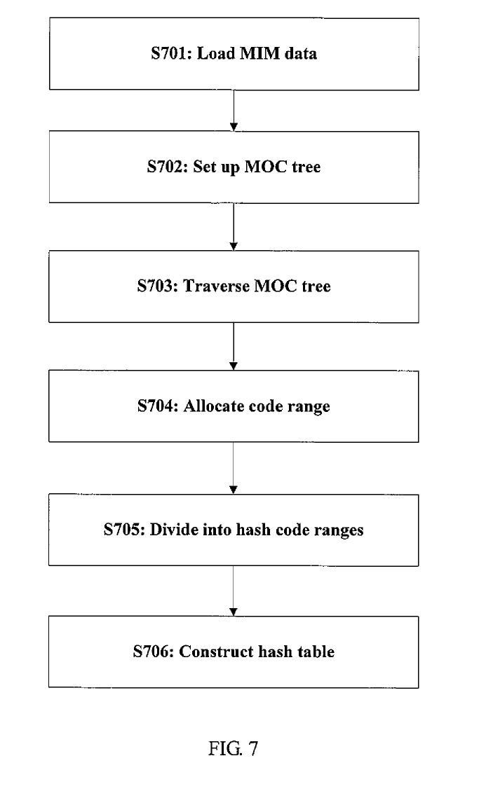

Initially, a constant hash table can be constructed for storing the network management information. FIG. 7 illustrates an exemplary initialization procedure according to embodiments of the present disclosure. During the initialization procedure, some parameters may be determined to support the range search operation of the constant hash table.

As shown in FIG. 7, at block S701, a management node (e.g., a Managed Element) may load its MIM data. MIM is pre-known in a managed element or a network management system. Such MIM data could be an XML file or any kinds of plain text file stored in the system. The MIM data contains all MOCs and their tree hierarchy information. For each MOC, the MIM data also contains a cardinal number which indicates the maximal number of MOs of the MOC under each parent MO of a parent MOC. Please be noted that, there might be the case that an MOC does not define a cardinal number. In this case, a number based on realistic analysis should be used as the cardinality. It should be appreciated that, the MIM may also comprise other information not mentioned herein.

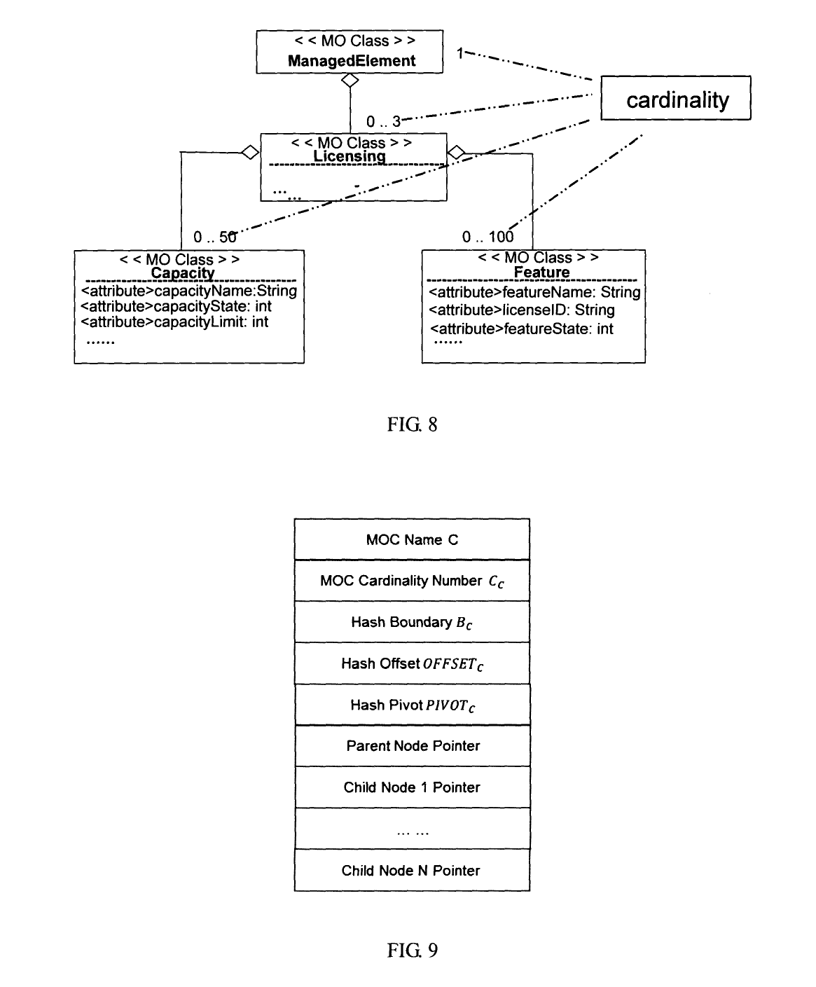

FIG. 8 illustrates an example of an MIM data in UML (Unified Modeling Language). As shown, this exemplary MIM data is illustrated in class diagram, comprising four MOCs, which are ManagedElement, Licensing, Capacity, and Feature. The parent-child inheritance relationships among the four MOCs are also illustrated, denoted by “⋄” in FIG. 8. Normally, a child MOC is a MOC that was derived from another, that will now be the parent to it. A parent MOC is the closest MOC from which the current MOC is derived, and the current MOC is referenced as a child MOC to the parent MOC. An ancestor MOC is an n-generation/level parent MOC, where n≧1. Similarly, a descendant MOC is an n-generation/level child MOC, where n≧1. For each MOC, there is a cardinal number to indicate the maximal number of MOs with the MOC under each parent MO of a parent MOC. For example, the cardinality of MOC ManagedElement is 1, the cardinality of MOC Licensing is 3, the cardinality of MOC Capacity is 50, while the cardinality of MOC Feature is 100. The MIM data can also contain various attribute values for these MOCs.

Returning to FIG. 7, at block S702, an MOC tree can be set up based on the loaded MIM data. The MOC tree contains all MOCs loaded from the MIM data and for each MOC, there is a corresponding tree node, which may be referred to as an MOC tree node or MOC node.

FIG. 9 illustrates an example implementation of an MOC tree node. As shown, each tree node contains the MOC name it represents. The MOC name can be a string for instance “UtranCell”, “NodeBFunction”, and etc. MOC Cardinal number contains the number of cardinality of the MOC defined in the MIM data.

Hash Boundary, Hash Offset and Hash Pivot are a few parameter entries which are used in the lookup algorithm. Each MOC has these three parameters, and the values for these parameters are all 0 at this moment. The meanings thereof will be described later.

An MOC tree node may also contain a pointer to its parent MOC tree node which is specified with “Parent Node Pointer” entry in FIG. 9. Meanwhile, an MOC tree node may have pointers to its child MOCs' tree nodes as well. Please be noted that, for the sake of brevity, the discussion herein does not take the case of multiple parent MOCs into consideration. However, the skilled person in the art could easily apply the principle disclosed herein for the multiple parent MOCs' situation under the teaching of the exemplary embodiments of the present disclosure.

In an example of implementation to set up the MOC tree, an ordinary hash table could be used to store all tree nodes during tree node creation by using the MOC name as the key. Such ordinary hash table will be called “MOC hash table” for purpose of simplification and clarity.

Once an MOC tree node is going to be created based on the data of an MOC, firstly its parent MOC's tree node may be retrieved from the MOC hash table with the parent MOC's name, and the pointer of the parent MOC tree node is stored into the current MOC tree node in the location as shown in FIG. 9. For the MOC's child MOCs, same process is performed as the parent MOC, and finally the created MOC tree node may be putted into the MOC hash table.

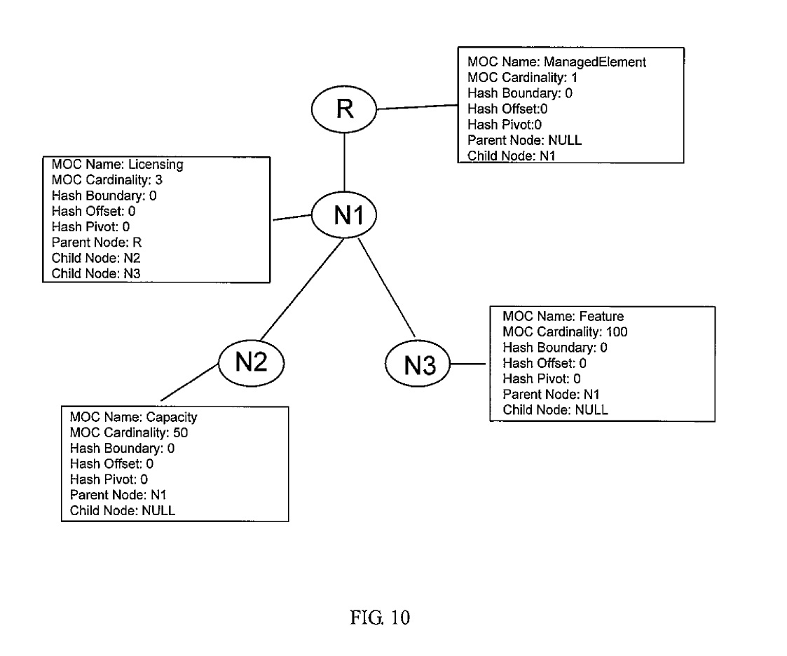

FIG. 10 illustrates an exemplary MOC tree structure according to embodiments herein. For illustration, this exemplary MOC tree is set up based on the loaded MIM data as shown in FIG. 8. As shown, for each MOC in the MIM, there is an MOC node. The root node R corresponds to the MOC ManagedElement, the node N1 corresponds to the MOC Licensing, the node N2 corresponds to the MOC Capacity, and the node N3 corresponds to the MOC Feature. In each MOC node structure, there is stored the cardinality of the MOC, its parent node, and its child nodes. At this moment, other parameters such as Hash Boundary, Hash Offset, and Hash Pivot are assigned as 0. For example, in the root node R, its cardinality is 1, its parent node points to NULL, and it has one child node N1. In the first level node N1, its cardinality is 3, its parent node is the root node R, and it has two child nodes N2 and N3. In the second level node N2, its cardinality is 50, its parent node is node N1, and it has no child node. Similarly, in the second level node N3, its cardinality is 100, its parent node is node N1, and it has no child node.

After the MOC tree is created, go back to block S703 in FIG. 7, and the MOC tree will be traversed. During the traversal, at block S704, a code range will be allocated for each traversed MOC node according to the order of traversing the MOC tree. All the code ranges for MOC nodes in the MOC tree constitute a code space. The allocation is based on a cardinal number of the current MOC node and cardinal numbers of its all ancestor MOC nodes till a root node. The code ranges can be arranged in an order consistent with the order of hash codes, i.e., an ascending order or a descending order. Such an ordered arrangement can preserve the order information among MOs of any MOC of the MOC tree. More specifically, values for a few important parameters will be decided to define the allocated code range.

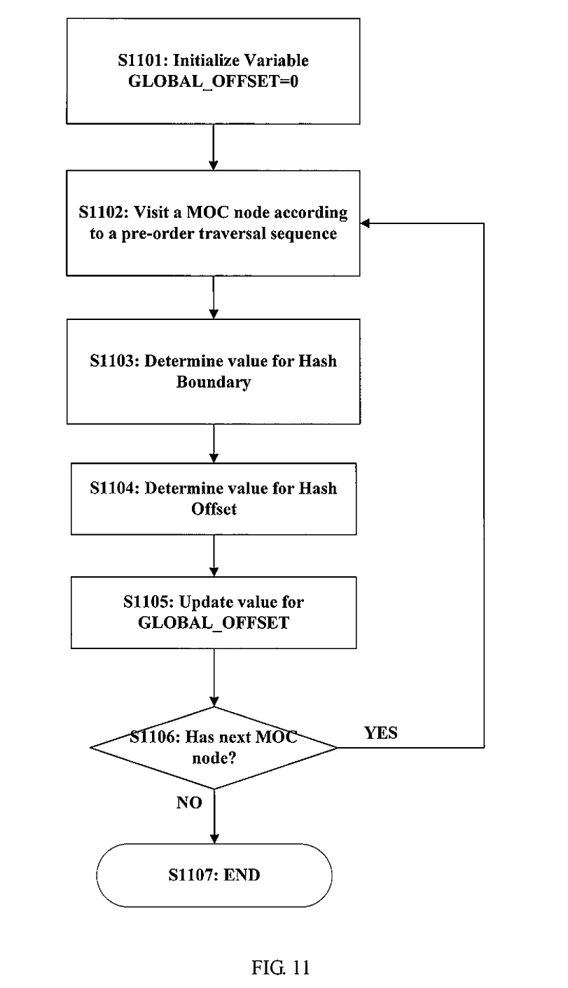

FIG. 11 illustrates an exemplary procedure for traversing the MOC tree and allocating code ranges according to embodiments herein.

First, at block S1101, a global variable GLOBAL_OFFSET is defined and initialized as 0. This global variable is used to track the allocation among the whole code space during the traversal of the MOC tree. The code space comprises codes of all possible instances of all MOC nodes in the MOC tree.

Then, at block S1102, the traversal of the MOC tree can be performed in a specific order where, for any MOC node, its ancestor MOC nodes are traversed prior to it. In one implementation, the MOC tree may be traversed by a pre-order traversal algorithm in depth-first traversal (i.e., first child, then grandchild before second child). Taking the MOC tree shown in FIG. 10 as an example, the pre-order traversal sequence is: R-N1-N2-N3 (root, left, right). In another implementation, the MOC tree may be traversed by a breadth-first traversal (i.e., first child, then second child before grandchildren). The breadth-first traversal can also be called level-order traversal, where we visit every node on a level before going to a lower level. As such, taking the MOC tree shown in FIG. 10 as an example, the breadth-first traversal sequence is: R-N1-N2-N3 (first level, second level, third level). For the example given in FIG. 10, these two traversal sequences are the same.

For each MOC node visited during the traversal, blocks S1103-S1105 will be executed sequentially to determine several parameter values for each tree node MOC C.

At block S1103, a value for the parameter hash boundary B_{C} of MOC C will be decided. The hash boundary B_{C} defines a size allocated for the possible instances of the MOC C, and more specifically, the number of MOs of the MOC C under each parent MO of a parent MOC of the MOC C. Particularly, if the cardinal number of the MOC C is 1, B_{C} can be 1. Otherwise, B_{C} can be a prime number greater than or equal to the cardinal number C_{C} of the MOC C.

To compute such a prime number, there are a few implementation methods. In an example of implementation, this could be done by creating a list of prime numbers. Since the cardinal numbers for all MOCs are pre-known, such a list of prime number only needs to cover the range of the cardinal numbers. When deciding the hash boundary B_{C}, the system may search the list to find the first prime number which is greater than the cardinal number C_{C}, and the first prime number is the value for B_{C} then.

In another implementation, a dividing algorithm may be used to find a prime number greater than the cardinal number C_{C}. The algorithm takes a natural number which is next to C_{C}, and uses the dividing algorithm to check whether it's a prime number. Specifically, it is checked whether none of the arithmetical compliments is 0, where the arithmetical compliments are computed by dividing the natural number by each prime number in a set of prime numbers one by one. The set of prime numbers includes prime numbers in a range from 2 till a square root of the natural number.

After the hash boundary B_{C} has been determined, at block S1104, a value for the parameter OFFSET_{C} of MOC C will be computed. The parameter OFFSET_{C} indicates an offset from the start of the code range allocated for the current MOC C to the initial point of the whole code space. Normally, the initial point of the whole code space may be set as 0 if the codes are arranged in an ascending order. In this case, for the root node, its OFFSET_{C} value is always 0; for any other MOC node, the value for OFFSET_{C} is always the present value of the variable GLOBAL_OFFSET. Those skilled in the art could appreciate that, if the codes are arranged in a descending order, the initial point of the whole code space may be set as the maximal value among the codes, and the hash offsets for the MOC nodes can be determined accordingly under the teaching of the present disclosure. Those hash offsets can indicate the order of the code ranges of the MOC nodes, which is consistent with the order of hash codes, as described previously.

Having determined the hash offset OFFSET_{C}, at block S1105, the variable GLOBAL_OFFSET can be updated. The new GLOBAL_OFFSET can be calculated as blow:

GLOBAL_OFFSET=GLOBAL_OFFSET+Π_{k=present node}^{parent node till root}Bₖ (5)

As seen from equation (5), the new GLOBAL_OFFSET value is the current GLOBAL_OFFSET value plus a product of a series of hash boundaries Bₖ of the present MOC tree node to its ancestor nodes till the root node. This product indicates the length of the code range allocated to the current MOC C.

Then, at block S1106, it is checked whether there is a next MOC node not yet visited. If yes, then the operation goes back to block S1102. For this next traversed MOC node, blocks S1103-S1105 are executed to determine its parameters. If all the MOC nodes have been visited during the traversal, then the operation proceeds to block S1107, where the traversal of the MOC tree and the allocation of the code range to each MOC node are ended.

Still take the MOC tree shown in FIG. 10 as an example. Suppose that a pre-order traverse sequence, i.e., R-N1-N2-N3, is adopted. First, the root node R will be visited. Since the cardinality of the root node R is 1, its hash boundary B_{R} can be determined as 1, its hash offset OFFSET_{R} can equal to 0. Then, the GLOBAL_OFFSET can be updated as: GLOBAL_OFFSET=0+B_{R}=1.

For the next MOC node N1, its cardinality is 3, which is a prime number, and thus the hash boundary B_{N1} can be determined as 3. The hash offset OFFSET_{N1} of node N1 equals to the current (i.e., updated) GLOBAL_OFFSET, i.e., 1. Also, the GLOBAL_OFFSET can be further updated as: GLOBAL_OFFSET=1+B_{N1}*B_{R}=4.

For the next MOC node N2, its cardinality is 50, and thus its hash boundary B_{N2} can be determined as a prime number greater than 50, e.g., 53. The hash offset OFFSET_{N2} of node N2 equals to the current (i.e., further updated) GLOBAL_OFFSET, i.e., 4. Also, the GLOBAL_OFFSET can be yet further updated as: GLOBAL_OFFSET=4+B_{N2}*B_{N1}*B_{R}=4+53*3*1=163.

For the last MOC node N3, its cardinality is 100, and thus its hash boundary BN₃ can be determined as 101. The hash offset OFFSET_{N3} of node N3 equals to the current (i.e., yet further updated) GLOBAL_OFFSET, i.e., 163. Also, the GLOBAL_OFFSET can be finally updated as: GLOBAL_OFFSET=163+B_{N3}*B_{N1}*B_{R}=163+101*3*1=466.

Returning to FIG. 7 again, having traversed the MOC tree and allocated code ranges for each MOC node in the MOC tree, the code space consisted of all the code ranges for MOC nodes in the MOC tree can be used as a hash code space (referred to as “a first hash code space” hereafter) for the first level slot array of the constant hash table to be constructed. Then, at block S705, the code space can be divided into hash code ranges with which the slots of the first level slot array are associated. The dividing can preserve the order of hash codes, i.e., an ascending order or a descending order.

Specifically, the first hash code space is consisted of hash codes from hₘᵢₙ to hₘₐₓ. Normally, the value for hₘᵢₙ may be always 0. The hₘₐₓ is assigned with the value of the variable GLOBAL_OFFSET after the traversal of the MOC tree. In the above example, the final updated GLOBAL_OFFSET is 466, and thus hₘₐₓ is 466. As described in the HASH TABLE part, the constant length N of the first level slot array of the proposed hash table can be determined based on a maximum possible number K of key-value pairs to be put into the hash table and a space factor S for the first level slot array. In this illustrated example, the maximum possible number K can be predicted as the total number of MOs belonging to all MOC nodes in the MOC tree. That is, K=466. Supposing that S is set as 0.1, that is, each slot in the first level slot array can be associated with at most 10 hash codes, then N can be calculated as: N=ROUND(K*S)=ROUND(466*0.1)=47. That is, the first level slot array have 47 slots.

Then, the density of hash codes can be calculated as:

$$D = CEIL ( \frac{{h}_{max} - {h}_{min}}{N} ) = CEIL ( \frac{466 - 0}{47} ) = 10.$$

In other words, the span of each hash code range of the slots of the first level slot array is 10.

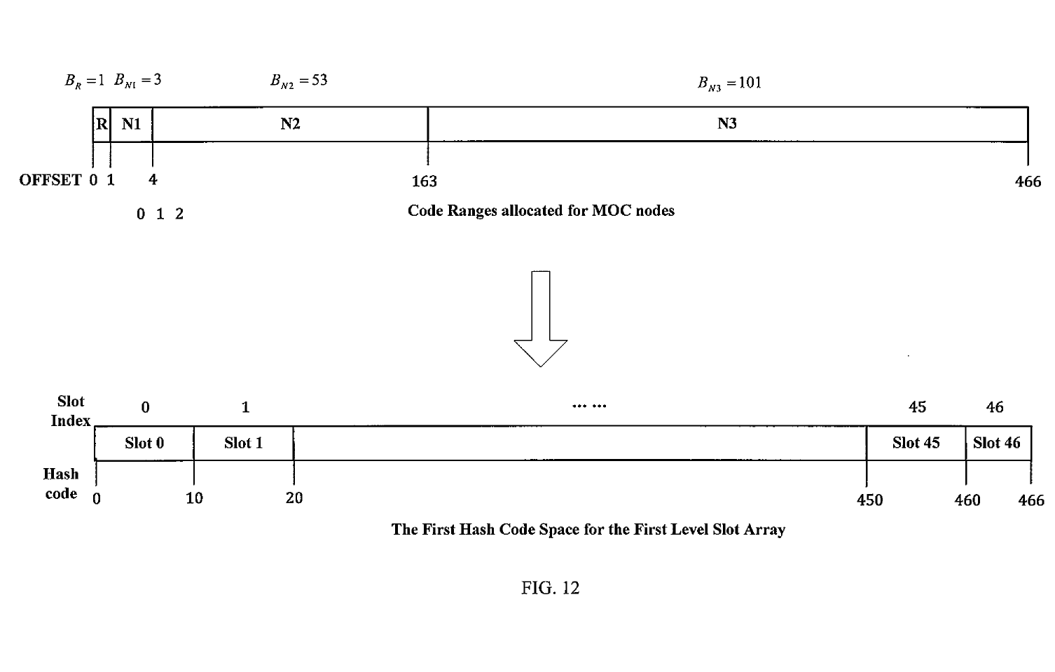

FIG. 12 illustrates the dividing of the code space according to embodiments herein. Please be noted that, the drawing is merely for illustration, and may be not drawn to scale.

The upper diagram of FIG. 12 shows the code space consisted of codes ranges allocated to each MOC nodes in the MOC tree as shown in FIG. 10.

With reference to the traversal of the MOC tree, code ranges are allocated to each MOC node in the MOC tree in an order consistent with the order of hash codes, which is an ascending order in this example. More specifically, as indicated by the parameter hash offset OFFSET of each node, a code range [0, 1) is allocated to the root node R, a code range [1, 4) is allocated to the second node N1 in the traversal sequence, a code range [4, 163) is allocated to the third node N2 in the traversal sequence, and a code range [163, 466) is allocated to the last node N3. The whole code space is [0, 466).

The lower diagram of FIG. 12 shows the first hash code space for the first level slot array of the constant hash table. The first hash code space may be same as the code space in the upper diagram. However, the first hash code space is divided according to slots of the first level slot array, preserving the order of hash codes.

In particular, as calculated above, the first level slot array has a length N of 47. Thus, these 47 slots may be indexed as 0, 1, 2, . . . , 46. Each slot can be associated with a hash code range according to the density D (D=10 in this example). For example, a hash code range [0, 10) is allocated to the slot 0, a hash code range [10, 20) is allocated to the slot 1, a hash code range [450, 460) is allocated to slot 45, and a hash code range [460, 466) is allocated to the last slot 46. As can be seen, each slot in the first level slot array will be associated with a fixed portion of the first hash code space, and this fixed portions are arranged in the order of the hash codes.

Going back to FIG. 7, Finally, at block S706, a constant hash table can be constructed with those given parameter such as hₘᵢₙ, hₘₐₓ, N, D, and a pointer parameter to a first hash function h(k) which will be described later.

After the initialization procedure, the data of Managed Objects could be inserted into the constant hash table, and thereby different types of retrieval requests are able to be handled by the system.

In the following, the hash function h(k) used as the first hash function for the first level slot array of the constant table will be described. The hash function h(k) is used to generate a hash code HASH_{IC} for MO I_{C}, and it can be invoked during PUT, GET, and DELETE operations of the constant hash table. Briefly, the hash function h(k) is arranged to map an MO's distinguished name (DN) to a hash code, preserving an order where a hash code of any MO belonging to any MOC is larger than a hash code of any MO belonging to any parent MOC of the MOC, or a hash code of any MO belonging to any MOC is smaller than a hash code of any MO belonging to any parent MOC of the MOC.

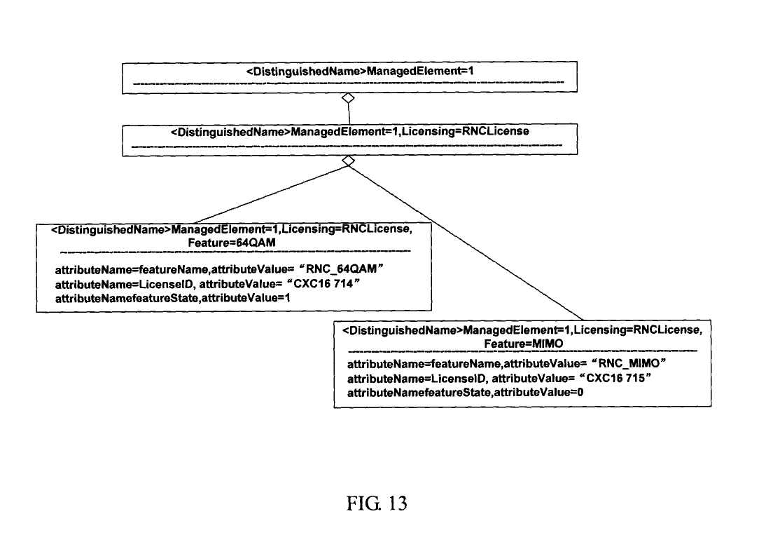

FIG. 13 illustrates an exemplary set of Managed Objects according to embodiments herein. As shown, these four MOs are instances of the MOCs in the MOC tree shown in FIG. 10, respectively. The root node is an MO “1” of MOC “ManagedElement”. The first level node is an MO “RNCLicense” of MOC “Licensing”, where the MO is contained under one parent MO, i.e., the root MO “ManagedElement=1”. The left second level node is an MO “64QAM” of MOC “Feature”, where the MO is contained under two ancestor MOs “Licensing=RNCLicense” and “ManagedElement=1”. The right second level node is an MO “MIMO” of MOC “Feature”, where the MO is also contained under two ancestor MOs “Licensing=RNCLicense” and “ManagedElement=1”.

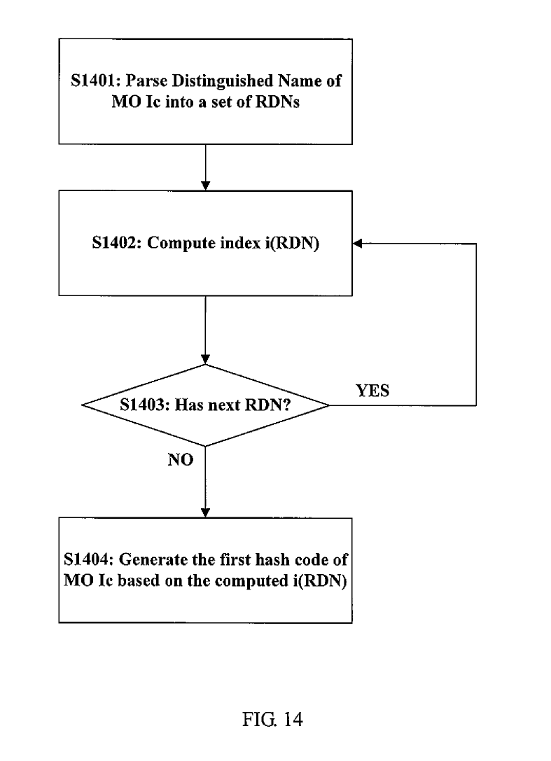

FIG. 14 illustrates an exemplary hash procedure according to embodiments herein. The hash procedure takes an MO I_{C}'s distinguished name (DN) as an input, and generates a hash code (i.e., a number) with the distinguished name.

According to 3GPP TS 32.300 Name convention for Managed Objects, a

Distinguished Name could be defined as below ASN.1 syntax:

### DistinguishedName ::=RDNSequence

### RDNSequence ::=SEQUENCE OF RelativeDistinguishedName

### RelativeDistinguishedName ::=SET SIZE (1..MAX) OF AttributeTypeAndValue

AttributeTypeAndValue ::=SEQUENCE {type AttributeType, value AttributeValue}

From the above definition and the TS 32.300, a DN could be parsed into a set of RelativeDistinguishedName (RDN), and each RelativeDistingsuishedName could be further parsed into an Attribute Type-Attribute Value pair.

Thus, at block S1401 of FIG. 14, the MO I_{C} 's distinguished name is parsed into a set of RDNs. In an example of implementation, the distinguished name could be a local distinguished name in current management context, for example “SubNetwork=ABCNetwork, SubNetwork=TN2, MSCFunction=B5C0100”. In another example of implementation, the distinguished name could be a global/full distinguished name, for example, “DC=com, DC=CompanyXYZ, DC=marketing, IRPAgent=ATMPVCBilling, Log=19990101131000, AccountingRecord=100098”. In such a case, at block 1401, a Global Root for example “DC=com, DC=CompanyXYZ, DC=marketing” may be needed to convert into a single RDN “DC=marketing.CompanyXYZ.com” at first.

For each RDN, at block S1402, a relative position i(RDN) of the RDN is determined within an allocated code range of an MOC to which the RDN belongs.

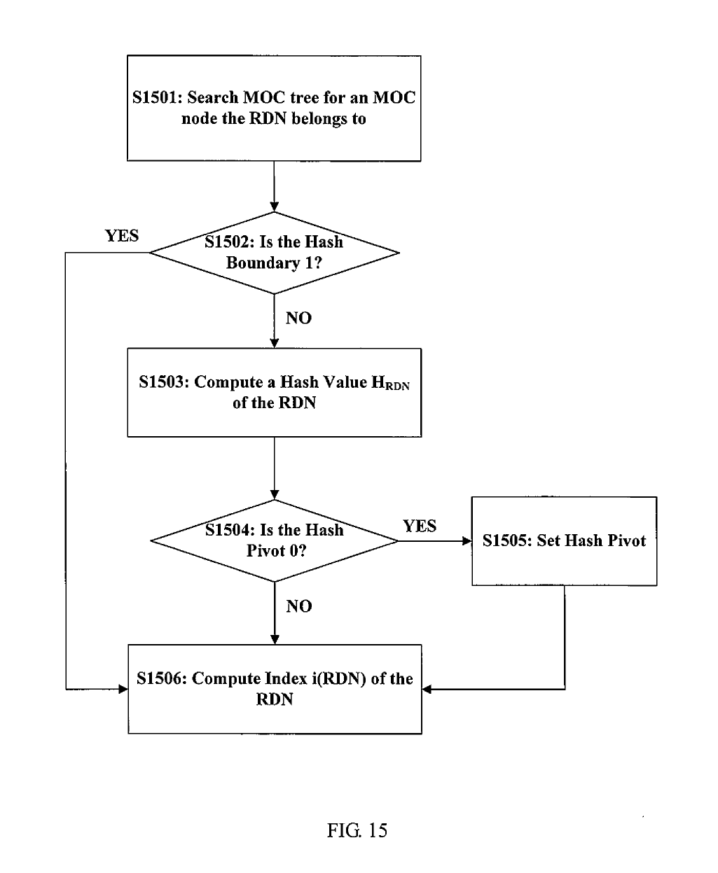

FIG. 15 illustrates an exemplary procedure for computing an index i(RDN) for each RDN in the distinguished name.

First at block S1501, the MOC tree as set up during the initialization procedure is searched for an MOC node the current RDN belongs to. As described previously, the MOC tree may be stored into an ordinary hash table, referred to as MOC hash table. The Attribute Type part of the RDN is the MOC name. In one implementation, the MOC name could be used as a key to search the MOC hash table for the MOC node.

Upon finding the MOC node, at block S1502, it is determined whether the hash boundary of this MOC node is 1. If it is true, which means this MOC node can only have one instance, then the operation jumps to block S1506 where the index of the RDN is set as 0, i.e., the first and only element. If it is not the case, the operation proceeds to block S1503.

At block S1503, a hash code H_{RDN} for this RDN is computed. In one implementation, the hash code H_{RDN} may be computed as blow:

$${H}_{RDN} = {\sum }_{i = 0}^{n - 1} ( {k}_{i} * {P}^{n - i - 1} ) \qquad ( 6 )$$

The equation (6) takes the Attribute Value part of a RDN as a string, where n is the length of the string in bytes, kᵢ is the i^{th} byte of the string, and P is a constant prime number e.g. 47.

Then at block S1504, it is checked whether the hash pivot of the MOC node is 0. If it is true, which means that this MOC node is empty, i.e., this MOC node has no instance yet and this is the first element or instance for the MOC node, then at block S1505, the pivot of the MOC node can be set as the hash code H_{RDN} of the RDN. In other words, the hash code of the first element of an MOC node will be set as a pivot for other subsequent elements of this MOC node, and thus the hash pivot of the MOC node is the hash code of the first element of this MOC node. The operation goes in turn to block S1506 where the index of the RDN is set as 0, i.e., the first element.

On the other hand, if the pivot is not 0, which means that this is not the first element for the MOC node, then the operation also goes to block S1506 to compute the index of this RDN.

At block S1506, the index of the RDN may be calculated as blow:

$$i ( RDN ) = \{ \begin{matrix}0 , & {PIVOT}_{C} = 0 or {B}_{C} = 1 \\ ( {H}_{RDN} - {PIVOT}_{C} ) mod {B}_{C} , & {H}_{RDN} \geq {PIVOT}_{C} \\ ( ( {H}_{RDN} - {PIVOT}_{C} ) mod {B}_{C} ) + {B}_{C} , & {H}_{RDN} < {PIVOT}_{C}\end{matrix} \qquad ( 7 ) )$$

where B_{C} represents the hash boundary for the current MOC C node, and PIVOT_{C} denotes the hash pivot of the MOC C node.

As seen from equation (7), the first sub equation corresponds to the case where this RDN is the first element in the MOC node or this RDN is the only element in the MOC node, while the other two sub equations correspond to other cases where there may be more than one elements, and this is not the first one in the MOC node. To limit the value of the index i(RDN) in a range of 0 to B_{C}−1, the difference between the hash code of the current RDN and the pivot (i.e., the hash code of the first element) is divided by the hash boundary B_{C}, and the remainder is the index. If the remainder is a negative value in the case that H_{RDN} is less than PIVOT_{C}, the index will be the remainder plus B_{C}.

Going back to FIG. 14, at block S1403, it is determined whether there is a next RDN unprocessed. If yes, then the operation turns to block S1402 and computes an index for this next RDN. If no, then the operation proceeds to block S1404 where the hash code for received MO may be generated based on the relative position of each RDN.

At block S1404, the hash code HASH_{IC} for the distinguished name of MO I_{C}. may be calculated with the following equation:

$${HASH}_{IC} = {OFFSET}_{C} + {\sum }_{i = {I}_{C}}^{parent MO till root} ( i ( {RDN}_{i} ) * {\prod }_{k = {I}_{C}}^{i - 1} {B}_{k} ) , where {\prod }_{k = {I}_{C}}^{{I}_{C} - 1} {B}_{k} = 1 \qquad ( 8 )$$

As seen, the hash code HASH_{IC} is a sum of the hash offset of the current MOC and another sum. The latter indicates the relative position of the MO I_{C}. within its MOC, which is determined by the index of each RDN and the hash boundaries of the current MOC to its parent MOC till the root MOC.

For better understanding, the following description takes the examples shown in FIGS. 10, 12, and 13 for illustrating the calculation of the hash code HASH_{IC}. Specifically, the MOC tree is as shown in FIG. 10, the code space allocation is as shown in FIG. 12, and the Managed Objects are as shown in FIG. 13.

For a given MO I3 with a distinguished name of “ManagedElement=1, Licensing=RNCLicense, Feature=MIMO”, the lowest MO shown in FIG. 13, its distinguished name can be parsed into three RDN, i.e., “ManagedElement=1”, “Licensing=RNCLicense” and “Feature=MIMO”.

For the RDN_{R} “ManagedElement=1”, the MOC it belongs to is the root node R, and thus the i(RDN_{R}) can be determined as 0 according to the description with respect to FIG. 15. For the RDN_{N1} “Licensing=RNCLicense”, the MOC it belongs to is the first level node N1, and suppose that i(RDN_{N1}) is determined as k1=2. For the RDN_{N3} “Feature=MIMO”, the MOC it belongs to is the second level node N3, and suppose that i(RDN_{N3}) is determined as k3=60.

Then, the hash code HASH_{I3} of the given MO I3 can be calculated as:

$$\begin{matrix}{HASH}_{I 3} = {OFFSET}_{N 3} + {\sum }_{i = N 3}^{N 1 to R} ( i ( {RDN}_{i} ) * {\prod }_{k = N 3}^{i - 1} {B}_{k} ) \\ == {OFFSET}_{N 3} + i ( {RDN}_{N 3} ) * {\prod }_{k = N 3}^{N 3 - 1} {B}_{k} + i ( {RDN}_{N 1} ) * {\prod }_{k = N 3}^{N 1 - 1} {B}_{k} + i ( {RDN}_{R} ) * {\prod }_{k = N 3}^{R - 1} {B}_{k} \\ = 163 + 60 * 1 + 2 * 101 + 0 * 101 * 3 = 435\end{matrix} \qquad ( 9 )$$

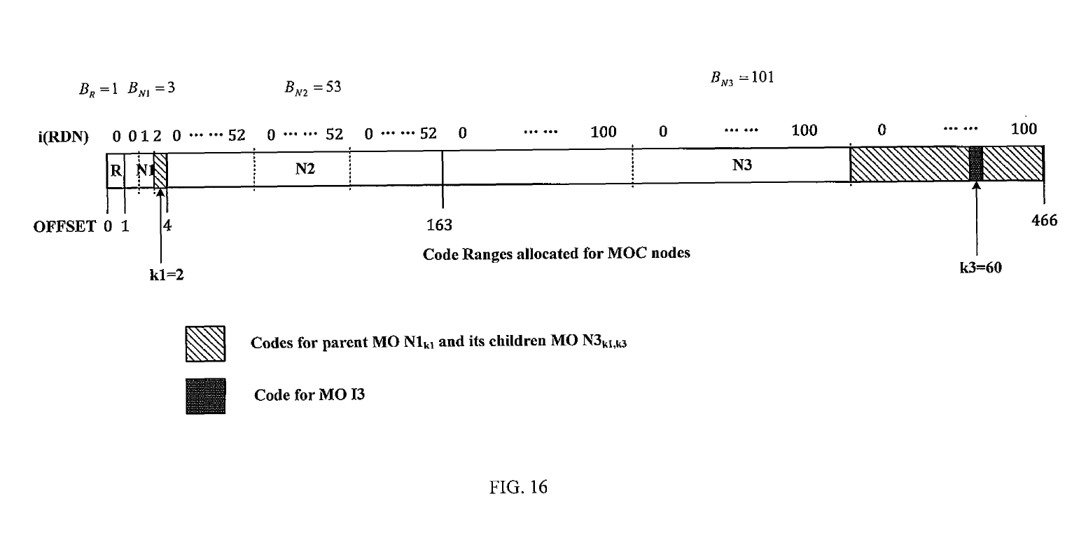

The meaning of this equation (9) can be seen clearly from FIG. 16. Same as FIG. 12, FIG. 16 illustrates the code space of the MOC tree as shown in FIG. 10 in more detail. FIG. 16 also shows the code ranges allocated for different MOs within each MOC.

For example, in the code range [1, 4) allocated to the MOC node N1, there are three codes 1, 2, and 3 (indexed as 0, 1, 2) for three MOs belonging to the MOC N1, respectively. In the code range [4, 163) allocated to the MOC node N2, there are three sub code ranges for three sets of MOs inheriting from the three MOs of the MOC N1, respectively. In each sub code range, these codes are indexed from 0 to B_{N2}−1, i.e., from 0 to 52. Also, in the code range [163, 466) allocated to the MOC node N3, there are three sub code ranges for three sets of MOs inheriting from the three MOs of the MOC N1, respectively. In each sub code range, these codes are indexed from 0 to B_{N3}−1, i.e., from 0 to 100.

FIG. 16 also shows the code range for an MO N1ₖ₁ and all its child MOs N3_{k1,k3} of MOC “N3”. The MO N1ₖ₁ is an MO of the MOC “N1”, and its index is k1, which is 2 in this example. All the children of MOC “N3” of this MO N1ₖ₁ are represented as MO N3_{k1,k3}, where k3=0, . . . , 100. For the given MO I3, it can be represented as MO N3_{2,60}.

Thus, for the given MO I3, its hash code can be determined by the relative positions (i.e., indexes) of all ancestor MOs within code ranges of respective MOCs, as calculated according to equation (9).

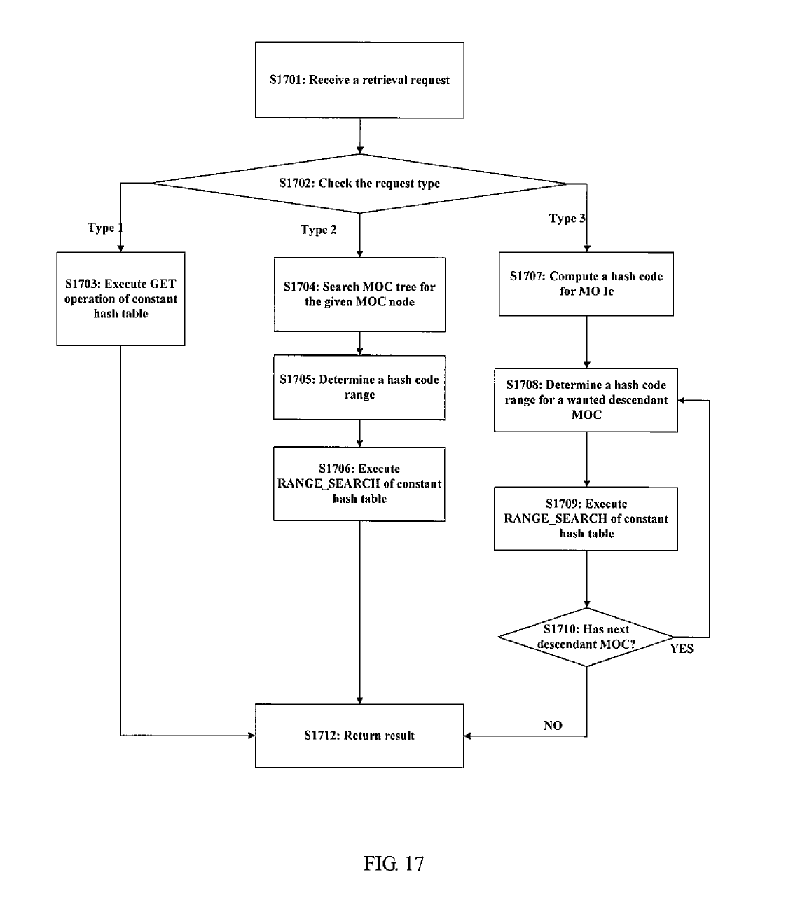

FIG. 17 illustrates a flowchart of RETRIEVE procedure of the network management information by using the constant hash table according to embodiments herein.

At block S1701, a retrieval request is received. As described previously, there are three types of retrieval requests:
Type 1: Retrieve a single MO data by providing the MO's distinguished name (DN);
Type 2: Retrieve a set of MOs' data of a same MOC by providing the MOC's name; and
Type 3: Retrieve a set of MOs' data of one or more MOCs, these MOs are all descendants from a same MO; by providing the MO's DN and the names of the one or more MOCs.

Additionally, all above three types of retrieval requests may contain a filter condition to filter target MOs. Such filter condition is further converted to a filter function with the filter condition as parameters.

Upon receiving a retrieval request, at block S1702, it is checked which type the received request is. Depending on the different types of the retrieval request, different operations may be performed.

In response to a first type of retrieval request, i.e., requesting retrieval of a single MO data by providing the MO's distinguished name (DN), the operation is branched to block S1703, where GET operation of the constant hash table is executed to get the intended MO. Details of GET operation may be referenced to the description with respect to FIGS. 4-5. Then, the intended MO can be retrieved and returned back at block S1712.

In response to a second type of retrieval request, i.e., retrieving data of a set of MOs belonging to a given MOC C by providing the given MOC C's name, the operation is branched to block S1704.

At block S1704, the MOC tree (and thus the MOC hash table as set up during initialization procedure in one implementation) will be searched for the given MOC C by using the MOC C's name as a key. Having found the MOC C node, its allocated code range can be obtained, which can be determined from the hash offset OFFSET_{C} of the MOC C node and hash boundaries of the MOC C node and of its all ancestor MOC nodes till the root node.

Then, at block S1705, a hash code range can be determined. This hash code range is a subset of the hash code space for the first level slot array of the constant hash table, which defines a range of the constant hash table to be searched. The start hash code hₛ can be determined as the start of the allocated code range, and the end hash code hₑ can be determined as the end of the allocated code range. Specifically, the start hash code hₛ may be assigned with the value of hash offset OFFSET_{C} of the MOC C node, and the end hash code hₑ can be calculated as below:

$${h}_{e} = {h}_{s} + {\prod }_{k = C}^{parent node till root} {B}_{k} \qquad ( 10 )$$

The second component in equation (10), i.e., the series multiplication result of the hash boundaries of the present MOC C node till its ultimate ancestor node, represents the length of the allocated code range for MOC C node, as explained with respect to equation (5).

Further at block S1706, the determined hash code range can be delivered to the constant hash table, and the RANGE_SEARCH operation of the constant hash table may be performed to handle this retrieval request by providing the parameters hₛ and hₑ and a pointer to a filter function if available. Details of RANGE_SEARCH operation may be referenced to the description with respect to FIG. 6. This operation finally returns intended MOs' data to the retrieval request at block S1712.

In response to a third type of retrieval request, i.e., retrieving data of a set of MOs belonging to one or more MOC, where the MOs in the set are all descendants from a given MO Ic, and the request contains the given MO Ic's DN and a set of MOC names which are descendents of the given MO Ic's MOC (denoted as MOC C), the operation is branched to block S1707.

At block S1707, the MO Ic's hash code HASH_{IC} can be calculated by using the hash function h(k) as described with respect to FIG. 14.

Further, for each descendent MOC M in the set of MOC names, a hash code range h′ₛ and h′ₑ is determined at block S1708.

More specifically, firstly, the MOC tree (and thus the MOC hash table) will be searched for the descendent MOC M by using the MOC M's name as a key. Having found the MOC M node, its allocated code range can be obtained. Then, a hash code range corresponding to descendents of the MO Ic can be extracted from the obtained allocated code range, based on the MO Ic's hash code HASH_{IC} as calculated at block S1707. The extracted range can be determined by a start hash code h′ₛ and an end hash code h′ₑ, which may be calculated as below:

$$\begin{matrix}{h}_{s}^{′} = {OFFSET}_{M} + ( {HASH}_{IC} - {OFFSET}_{C} ) * {\prod }_{k = M}^{parent node till {I}_{C} - 1} {B}_{k} & ( 11 ) \\ {h}_{e}^{′} = {h}_{s}^{′} + {\prod }_{k = M}^{parent node till Ic - 1} {B}_{k} & ( 12 )\end{matrix}$$

In equation (11), the item OFFSET_{M} represents the start of the allocated code range for the descendent MOC M, OFFSET_{C} represents the start of the allocated code range for the current MOC C, the item HASH_{IC}−OFFSET_{C} represents the relative position of the MO Ic within the code range allocated for its MOC C node; the item

$${\prod }_{k = M}^{parent node till {I}_{C} - 1} {B}_{k}$$

represents the length of the code range for descendent MOs with the MOC M under each parent MO of the MOC C, and thus the product of HASH_{IC}−OFFSET_{C} and

$${\prod }_{k = M}^{parent node till {I}_{C} - 1} {B}_{k}$$

represents how many codes have been occupied by descendent MOs with the MOC M inheriting from MOs with the MOC C, whose relative positions are ahead of that of the MO Ic within the allocated code range for the MOC C node. Similarly, in equation (12), the item

$${\prod }_{k = M}^{parent node till {I}_{C} - 1} {B}_{k}$$

represents the length of the code range for descendent MOs with the MOC M under each parent MO of the MOC C.

Then, at block S1709, the determined hash code range can be delivered to the constant hash table, and the RANGE_SEARCH operation of the constant hash table may be performed to handle this retrieval request by providing the parameters h′ₛ and h′ₑ and a pointer to a filter function if available.

At block S1710, it is checked whether there is any wanted descendant MOC not yet searched. In this way, blocks S1708 and S1709 are repeated for each searched descendent MOC M, until all wanted MOCs are searched.

This operation finally returns intended MOs' data to the retrieval request at block S1712.

Thus the above has described a hash method designed for the network management information and used for the constant hash table provided herein. Also, a method for managed objects lookup is provided, where the constant hash table is used to cache MO's data in current management context.

As seen from the above description, the proposed management information lookup algorithm has several advantages over existing solutions.

First, the time complexity for 2^{nd} type request is better than the combination solution as described in the Background, while same time complexity for 1^{st} and 3^{rd} type requests as the combination solution is kept and it's better than the only hash table solution. Please be noted that, the exact time complexity for 2^{nd} type request relates to the cardinality multiplication of a MOC hierarchy. However, for most of cases, the value is still a limited constant number.

Second, it is easy to maintain the consistency between the hash table and the MIB, because there is no other data structure to assist the constant hash table, just as the hash table solution. Third, memory consumption is smaller than the hash table and tree data structure combination solution, because no additional relationship is needed to be stored. Fourth, it is very suitable for a large number of MOs in a management context, because the second level slot arrays of the constant hash table could be deployed in a distributed cache systems. At last, the proposed algorithm uses multiplication and plus operations, which are very fast in computer processor instruction execution.

### Implementations

FIG. 18 illustrates a general system where embodiments of the present disclosure may be implemented. As shown in FIG. 18, the system 1800 may comprise a constant hash table module 1810, an initialization module 1820, a hash function module 1830, and a search module 1840.

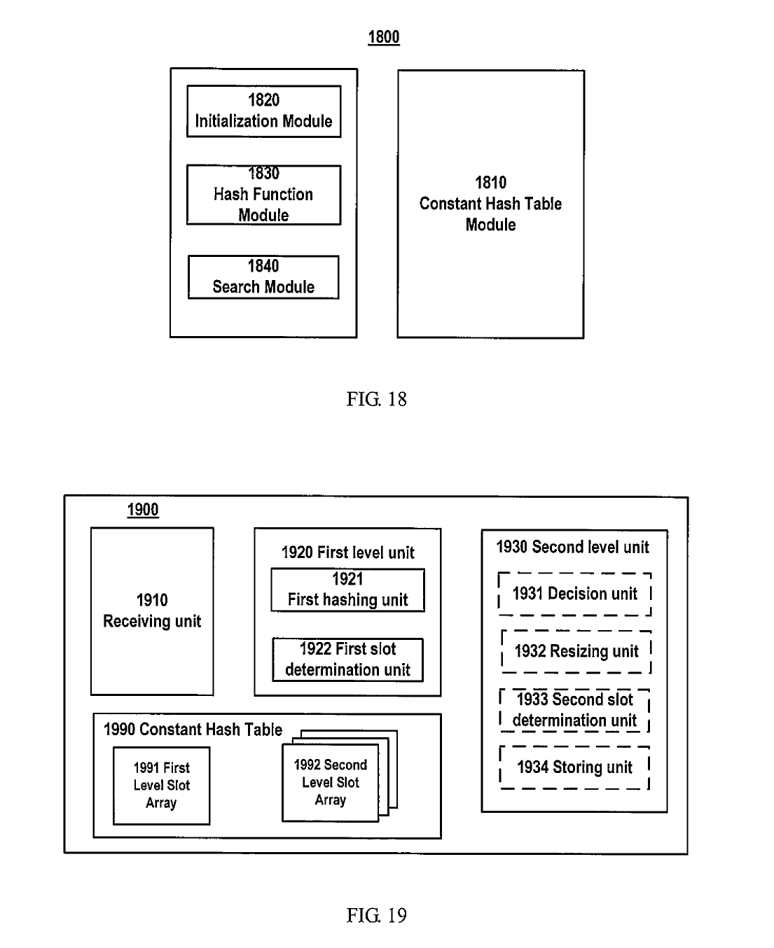

The constant hash table module 1810 may be configured to implement the constant hash table as described above, which will be detailed with reference to FIG. 19.

The initialization module 1820 may be configured to initialize all needed modules and parameters, such as determining some parameters e.g., hash boundary, hash offset, etc., by traversing an MOC tree. The initialization procedure has been described with reference to FIGS. 7-12, and thus the detail is omitted herein.

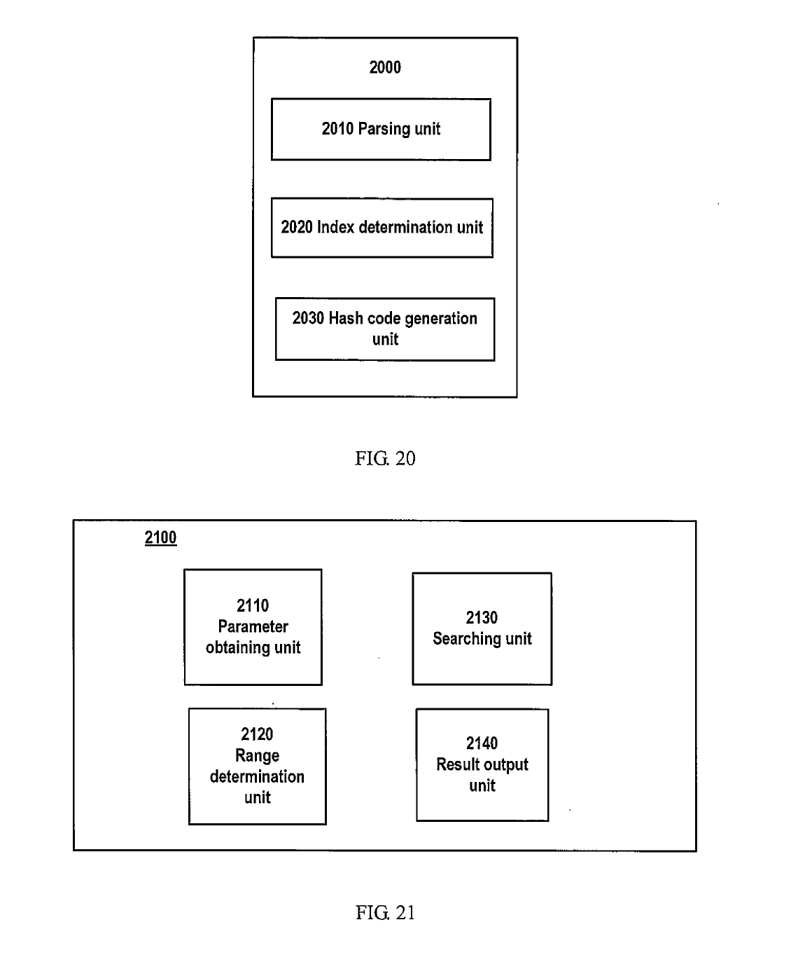

The hash function module 1830 may be configured to generate a hash code from an MO's distinguished name. It can be defined by the user and provided to the constant hash table module 1810 to determine a slot position in the first level slot array. The operation of the hash function module 1830 has been described with reference to FIGS. 14-15, and its detailed structure will be described blow with respect to FIG. 20.

The search module 1840 is the frontend of handling various MO retrieval requests. It may be configured to execute GET operation from the constant hash table 1810, or compute a hash code range and execute RANGE_SEARCH operation from the constant hash table 1810 to obtain needed MO's data. During these operations, the hash function module 1830 may be used to obtain a hash code.

From the view of deployment, the system 1800 may be deployed on a single computer or on different computers. Further, even the constant hash table module 1810 may be deployed on a single computer or distributed on different computers, as mentioned previously.

FIG. 19 illustrates a schematic block diagram of an apparatus that may be configured to implement the constant hash table module 1810 as shown in FIG. 18. The apparatus 1900 comprises a constant hash table 1990, which comprises a first level slot array 1991 with a constant number of slots and at least one second level slot array 1992 with a variant number of slots. Each slot of the first level slot array is associated with a hash code range generated with a first hash function and is linked to at most one second level slot array.

As shown in FIG. 19, the apparatus 1900 further comprises a receiving unit 1910, a first level unit 1920, and a second level unit 1930.

The receiving unit 1910 is configured to receive data to be processed, the data being represented by a key and value pair.

The first level unit 1920 comprises a first hashing unit 1921 and a first slot determination unit 1922. The first hashing unit 1921 is configured to obtain a first hash code which is generated from the received key according to a first hash function. The first hash function h(k) may be preconfigured internally or may be provided by a user, e.g., through the hash function module 1830 shown in FIG. 18. In this regard, in one implementation, the first hashing unit 1921 can invoke the hash function module 1830 to generate the first hash code, or the first hash code can be generated at the hash function module 1830 and delivered to the first hashing unit 1921 directly. The first slot determination unit 1922 is configured to determine a slot of the first level slot array associated with a hash code range to which the first hash code corresponds.

The second level unit 1930 is configured to store the key and value pair into a second level slot array to which the determined slot of the first level slot array is linked. More specifically, in some embodiments, the second level unit 1930 may comprise a decision unit 1931, a resizing unit 1932, a second slot determination unit 1933, and a storing unit 1934.

The decision unit 1931 may be configured to decide whether the second level slot array needs resizing or rehash. The decision may be based on the load factor, as described previously.

The resizing unit 1932 may be configured to resize or rehash the second level slot array in response that the second level slot array needs resizing or rehash. The resizing unit 1932 may apply a common approach for resizing or rehash. Briefly, a new array of slots with increased length is allocated, all the entries of the original slot array are relocated to this new array one by one, and the original slot array is returned to the free storage pool.

The second slot determination unit 1933 may be configured to determine a slot in the second level slot array or in the resized second level slot array for storing the key and value pair. The determination may be based on a second hash code generated from the received key according to a second hash function. The second hash function may be same as or different from the first hash function. With the second hash code, an index function may be called to determine the index of a slot of the second level slot array or the resized second level slot array to store the key and value pair.

The storing unit 1934 may be configured to store the key and value pair into the decided position of the (resized) second level slot array as a hash entry.

The apparatus 1900 may further comprise an initialization unit (not shown), which may be configured to initialized the constant table. For example, the initialization unit may be configured to determine the length of the first level slot array of the constant hash table based on a maximum possible number of elements (key-value pairs) putting into the constant hash table and a space factor for the first level slot array. The initialization unit may be configured to determine some other parameters necessary for the constant hash table, such as density D of hash codes, as described above.

FIG. 20 illustrates a schematic block diagram of an apparatus that may be configured to implement the hash function module 1830 as shown in FIG. 18. The hash function is arranged to map a distinguished name (DN) of a managed object (MO) to a hash code, preserving an order where a hash code of any MO belonging to any MOC is larger than a hash code of any MO belonging to any parent MOC of the MOC, or a hash code of any MO belonging to any MOC is smaller than a hash code of any MO belonging to any parent MOC of the MOC.

The apparatus 2000 may comprise a parsing unit 2010, an index determination unit 2020, and a hash code generation unit 2030.

The parsing unit 2010 may be configured to parse the MO's DN into a set of RDN.

For each RDN, the index determination unit 2020 may be configured to determine a relative position i(RDN) of the RDN within an allocated code range of an MOC to which the RDN belongs. The details for the index determination may be referenced to the description with respect to FIG. 15.

The hash code generation unit 2030 may be configured to generate a hash code based on the relative positions of those parsed RDN as determined by the index determination unit 2020. For example, the hash code generation unit 2030 may calculate the hash code according to the equation (8) as described above.

FIG. 21 illustrates a schematic block diagram of an apparatus that may be configured to implement the search module 1840 as shown in FIG. 18. The apparatus 2100 may be configured to search data in a range of the constant hash table. The apparatus 2100 comprises a parameter obtaining unit 2110, a range determination unit 2120, a searching unit 2130, and a result output unit 2140.

The parameter obtaining unit 2110 is configured to obtain a start hash code and an end hash code which define the range of the hash table. In one implementation, the start hash code and the end hash code may be received directly. In another implementation, a start key and an end key may be received e.g. by a receiving unit (not shown) in the parameter obtaining unit 2110. Then, a hashing unit (not shown) in the parameter obtaining unit 2110 may be configured to generate the start hash code from the start key, and generate the end hash code from the end key e.g., by invoking the hash function module 1830 in FIG. 18.

The range determination unit 2120 is configured to determine a slot range of the first level slot array of the constant hash table. A start slot of the slot range is associated with a hash code range to which the start hash code corresponds, and an end slot of the slot range is associated with a hash code range to which the end hash code corresponds. The start slot and the end slot can be determined by using the equation (3). Thus, the start slot and the end slot decides a range in the first level slot array.

The searching unit 2130 is configured to, for each second level slot array to which each slot within the slot range is linked, search hash entries in the second level slot array. The searched hash entries are output by the result output unit 2140.

Additionally, the apparatus may comprise a filtering unit (not shown). The filtering unit may be configured to filter hash entries in the searched range with a filtering condition which may be received via the parameter obtaining unit 2110. The filtering may be performed either during traversing hash entries in each second level slot array in the slot range or after returning the searched hash entries.

Depending on the type of the retrieval requests, the parameter obtaining unit 2110 may be configured to perform different operations. For the first type of retrieval request, GET operation of the constant hash table can be executed to get the intended MO.

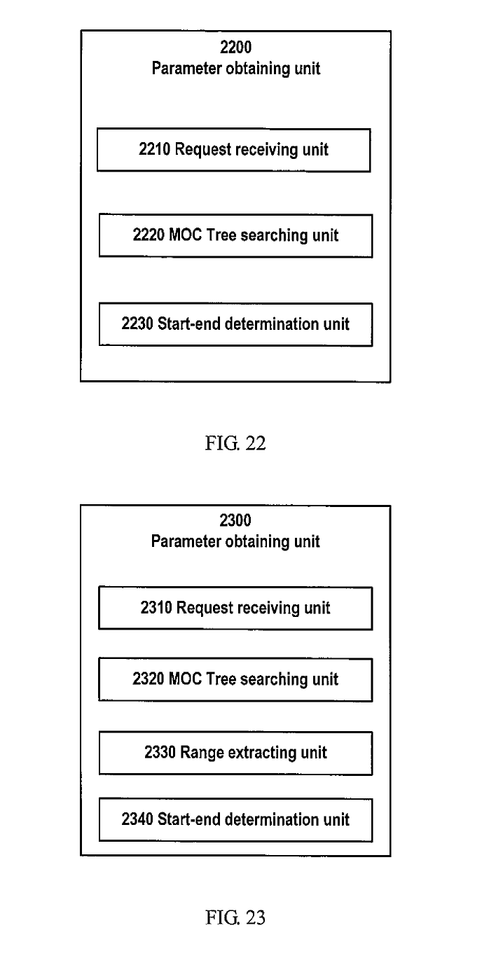

FIG. 22 illustrates an example implementation 2200 of the parameter obtaining unit 2110 as shown in FIG. 21 for handling the second type of retrieval request.

As shown, in this implementation, the parameter obtaining unit 2200 may comprise a request receiving unit 2210, which is configured to receive a retrieval request for retrieving data of a set of MOs belonging to a given MOC. The retrieval request contains the given MOC's name.

The parameter obtaining unit 2200 may further comprise a MOC tree searching unit 2220, which is configured to search the MOC tree (and thus the MOC hash table as set up during initialization procedure by the initialization module 1820 in FIG. 18) for the given MOC by using the MOC's name as a key. Having found the MOC node, its allocated code range can be obtained, which can be determined from the hash offset OFFSET_{C} of the MOC C node and hash boundaries of the MOC C node and of its all ancestor MOC nodes till the root node.

The parameter obtaining unit 2200 may further comprise a start-end determination unit 2230, which is configured to determine the start hash code as the start of the allocated code range, and the end hash code as the end of the allocated code range.

Then, the determined hash code range, i.e., the start hash code and the end hash code, can be delivered to the range determination unit 2120 in FIG. 21 to perform RANGE_SEARCH operation of the constant hash table.

FIG. 23 illustrates another example implementation 2300 of the parameter obtaining unit 2110 as shown in FIG. 21 for handling the third type of retrieval request.

As shown, in this implementation, the parameter obtaining unit 2300 may comprise a request receiving unit 2310, which is configured to receive a retrieval request for retrieving data of a set of MOs belonging to one or more MOCs. The MOs in the set are all descendants from a given MO. The retrieval request contains the given MO's DN, and a set of MOC names which are descendents of the given MO's MOC.

The parameter obtaining unit 2300 may further comprise a MOC tree searching unit 2320, which is configured to, for each descendent MOC, search the MOC tree (and thus the MOC hash table as set up during initialization procedure by the initialization module 1820 in FIG. 18) for the descendent MOC by using its name as a key. Having found the descendent MOC node, its allocated code range can be obtained.

The parameter obtaining unit 2300 may further comprise a range extracting unit 2330, which is configured to, for each descendent MOC, extract a hash code range corresponding to descendents of the given MO from the obtained allocated code range, based on a hash code of the given MO generated according to the hash function provided by the hash function module 1830 in FIG. 18.

Also, the parameter obtaining unit 2300 may further comprise a start-end determination unit 2340, which is configured to, for each descendent MOC, determine the start hash code as the start of the allocated code range, and the end hash code as the end of the allocated code range.

Then, the determined hash code range for each descendent MOC, i.e., the start hash code and the end hash code, can be delivered to the range determination unit 2120 in FIG. 21 to perform RANGE_SEARCH operation of the constant hash table.

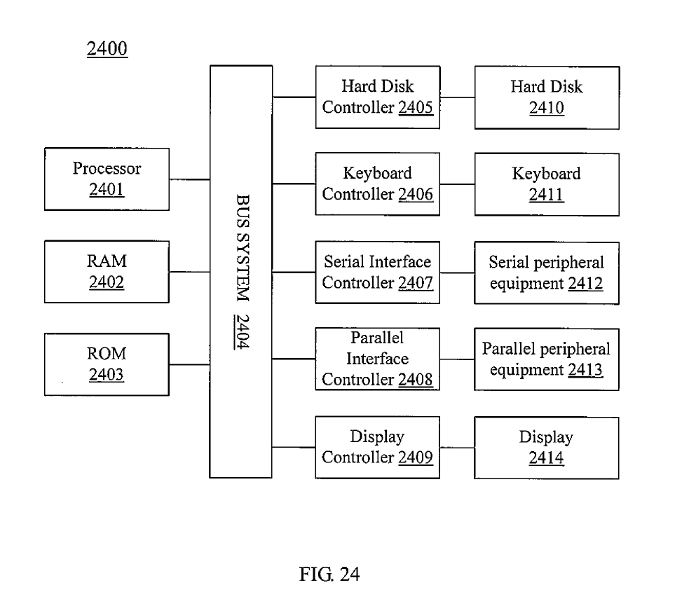

FIG. 24 shows an exemplary computer system 2400 which is applicable to implement the embodiments of the present disclosure.

As shown in FIG. 24, the computer system 2400 may include: at least one processor, e.g., CPU (Central Process Unit) 2401, at least one memory, e.g., RAM (Random Access Memory) 2402 and ROM (Read Only Memory) 2403, System Bus 2404, Hard Drive Controller 2405, Keyboard Controller 2406, Serial Interface Controller 2407, Parallel Interface Controller 2408, Display Controller 2409, Hard Drive 2410, Keyboard 2411, Serial Peripheral Equipment 2412, Parallel Peripheral Equipment 2413 and Display 2414. Among above devices, CPU 2401, RAM 2402, ROM 2403, Hard Drive Controller 2405, Keyboard Controller 2406, Serial Interface Controller 2407, Parallel Interface Controller 2408 and Display Controller 2409 are coupled to the System Bus 2404. Hard Drive 2410 is coupled to Hard Drive Controller 2405. Keyboard 2411 is coupled to Keyboard Controller 2406. Serial Peripheral Equipment 2412 is coupled to Serial Interface Controller 2407. Parallel Peripheral Equipment 2413 is coupled to Parallel Interface Controller 2408. And, Display 2414 is coupled to Display Controller 2409. It should be understood that the structure as shown in FIG. 24 is only for the exemplary purpose rather than any limitation to the present disclosure. In some cases, some devices may be added to or removed from the computer system 2400 based on specific situations. The computer system 2400 may be configured to perform various embodiments of methods as described herein.

In some embodiments, the computer system may be configured to process data in a hash table. The hash table may be stored in a RAM, e.g., a cache. The hash table comprises a first level slot array with a constant number of slots and at least one second level slot array with a variant number of slots. Each slot of the first level slot array is associated with a hash code range generated with a first hash function, and each slot of the first level slot array is linked to at most one second level slot array. The at least one memory of the computer system contains instructions executable by the at least one processor, whereby the computer system is operative to: receive data to be processed, the data being represented by a key and value pair; obtain a first hash code which is generated from the key according to the first hash function; determine a slot of the first level slot array associated with a hash code range to which the first hash code corresponds; and store the key and value pair into a second level slot array to which the determined slot of the first level slot array is linked.

In some other embodiments, the computer system may be configured to retrieve data from a hash table. The hash table may be stored in a RAM, e.g., a cache. The hash table comprises a first level slot array with a constant number of slots and at least one second level slot array with a variant number of slots. Each slot of the first level slot array is associated with a hash code range generated with a first hash function, and each slot of the first level slot array is linked to at most one second level slot array. The at least one memory of the computer system contains instructions executable by the at least one processor, whereby the computer system is operative to: receive a key; obtain a first hash code which is generated from the key according to the first hash function; determine a slot of the first level slot array associated with a hash code range to which the first hash code corresponds; and retrieve a value corresponding to the key from a second level slot array to which the determined slot of the first level slot array is linked.

In some further embodiments, the computer system may be configured to search data in a specific range of a hash table. The hash table may be stored in a RAM, e.g., a cache. The hash table comprises a first level slot array with a constant number of slots and at least one second level slot array with a variant number of slots. Each slot of the first level slot array is associated with a hash code range generated with a first hash function, and each slot of the first level slot array is linked to at most one second level slot array. The at least one memory of the computer system contains instructions executable by the at least one processor, whereby the computer system is operative to: obtain a start hash code and an end hash code; determine a slot range of the first level slot array, wherein a start slot of the slot range is associated with a hash code range to which the start hash code corresponds, and an end slot of the slot range is associated with a hash code range to which the end hash code corresponds; for each second level slot array to which each slot within the slot range of the first level slot array is linked, search hash entries in the second level slot array; and return searched hash entries.

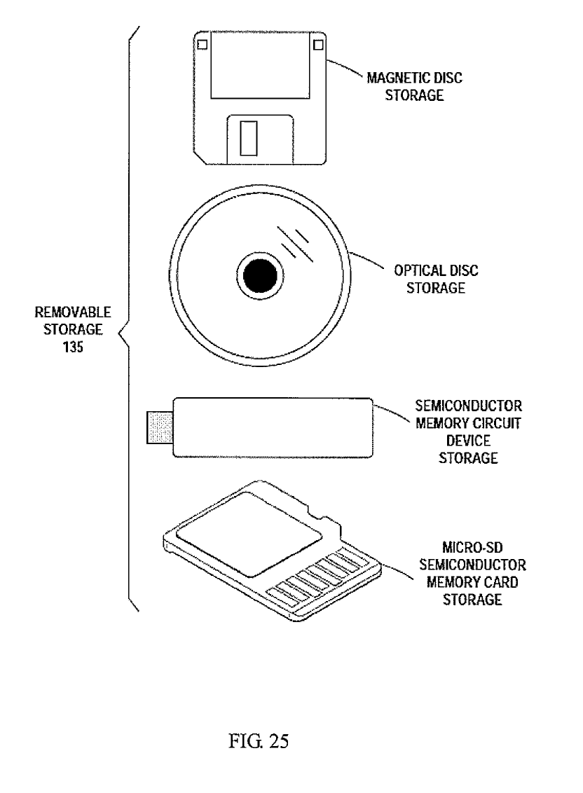

The instructions mentioned above may arrive at the computer system via an electromagnetic carrier signal or be copied from a physical entity such as a computer program product, a non-volatile electronic memory device (e.g. flash memory) or a storage medium 135 as shown in FIG. 25, such as a magnetic disc storage, optical disc storage, semiconductor memory circuit device storage, micro-SD semiconductor memory card storage.

Exemplary embodiments herein have been described above with reference to block diagrams and flowchart illustrations of methods, apparatuses (i.e., systems). It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

The foregoing computer program instructions can be, for example, sub-routines and/or functions. A computer program product in one embodiment comprises at least one computer readable storage medium, on which the foregoing computer program instructions are stored. The computer readable storage medium can be, for example, an optical compact disk or an electronic memory device like a RAM (random access memory) or a ROM (read only memory).

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It should also be noted that the above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims. In addition, any of the reference numerals in the claims should not be interpreted as a limitation to the claims. Use of the verb “comprise” and its conjugations does not exclude the presence of elements or steps other than those stated in a claim. The indefinite article “a” or “an” preceding an element or step does not exclude the presence of a plurality of such elements or steps.

1. A method for processing data in a hash table, wherein said hash table comprises a first level slot array with a constant number of slots and at least one second level slot array with a variant number of slots, each slot of the first level slot array being associated with a hash code range generated with a first hash function, and each slot of the first level slot array being linked to at most one second level slot array, said method comprising:
receiving data to be processed, said data being represented by a key and value pair;
obtaining a first hash code which is generated from the key according to the first hash function;
determining a slot of the first level slot array associated with a hash code range to which the first hash code corresponds; and
storing said key and value pair into a second level slot array to which the determined slot of the first level slot array is linked.

2. The method of claim 1, wherein the constant number N of slots of the first level slot array is determined based on a maximum possible number of key and value pairs to be put into said hash table and a space factor for the first level slot array.

3. The method of claim 1, wherein slots of the first level slot array are arranged to be associated with a respective hash code range in the order of hash codes generated according to the first hash function.

4. The method of claim 1, wherein storing said key and value pair into a second level slot array comprises:
deciding whether the second level slot array needs resizing;
resizing the second level slot array in response that the second level slot array needs resizing;
determining a slot of the second level slot array or of the resized second level slot array from said key according to a second hash function; and
storing said key and value pair into the determined slot of the second level slot array or of the resized second level slot array as a hash entry.

5. The method of claim 1, wherein
said data includes network management information consisted of a set of managed objects, a managed object belongs to a managed object class, MOC, a set of MOCs is represented by an MOC tree based on parent-child inheritance relationships among the MOCs, the managed object's distinguished name is used as a key, and the managed object's data is a value associated with the key, and
said first hash function is arranged to map a distinguished name of a managed object to a first hash code, preserving an order where a hash code of any MO belonging to any MOC is larger than a hash code of any MO belonging to any parent MOC of the MOC, or a hash code of any MO belonging to any MOC is smaller than a hash code of any MO belonging to any parent MOC of the MOC.

6. The method of claim 5, wherein said hash table is initialized by:
traversing the MOC tree in an order that, for any MOC node, its ancestor MOC nodes are traversed prior to it;
for each traversed MOC node, allocating a code range based on a cardinal number of the MOC node and cardinal numbers of its all ancestor MOC nodes till a root node; and
dividing a space consisted of the code ranges into hash code ranges with which the slots of the first level slot array are associated.

7. The method of claim 6, wherein said first hash function is arranged to map a distinguished name of a managed object to a first hash code by:
parsing the managed object's distinguished name into a set of relative distinguished names, RDNs;
for each RDN, determining a relative position i(RDN) of said RDN within an allocated code range of a MOC node to which said RDN belongs; and
generating the first hash code based on the relative position of each RDN.

8. A method for retrieving data from a hash table, wherein said hash table comprises a first level slot array with a constant number of slots and at least one second level slot array with a variant number of slots, each slot of the first level slot array being associated with a hash code range generated with a first hash function, and each slot of the first level slot array being linked to at most one second level slot array, and wherein said data represented by key and value pairs are stored as hash entries in the hash table, said method comprising:
receiving a key;
obtaining a first hash code which is generated from the key according to the first hash function;
determining a slot of the first level slot array associated with a hash code range to which the first hash code corresponds; and
retrieving a value corresponding to said key from a second level slot array to which the determined slot of the first level slot array is linked.

9. The method of claim 8, wherein slots of the first level slot array are arranged to be associated with a respective hash code range in the order of hash codes generated according to the first hash function.

10. A method for searching data in a range of a hash table, wherein said hash table comprises a first level slot array with a constant number of slots and at least one second level slot array with a variant number of slots, each slot of the first level slot array being associated with a hash code range in the order of hash codes generated with a first hash function, and each slot of the first level slot array being linked to at most one second level slot array, and wherein said data represented by key and value pairs are stored as hash entries in the hash table, said method comprising:
obtaining a start hash code and an end hash code which define the range of the hash table;
determining a slot range of the first level slot array, wherein a start slot of the slot range is associated with a hash code range to which the start hash code corresponds, and an end slot of the slot range is associated with a hash code range to which the end hash code corresponds;
searching hash entries in each second level slot array to which each slot within the slot range is linked; and
returning searched hash entries.

11. The method of claim 10, wherein obtaining a start hash code and an end hash code comprises:
receiving a start key and an end key; and
generating the start hash code from the start key according to the first hash function and the end hash code from the end key according to the first hash function.

12. The method of claim 10, wherein
said data includes network management information consisted of a set of managed objects, a managed object belongs to a managed object class, MOC, a set of MOCs is represented by an MOC tree based on parent-child inheritance relationships among the MOCs, the managed object's distinguished name is used as a key, and the managed object's data is a value associated with the key, and
said first hash function is arranged to map a distinguished name of a managed object to a first hash code, preserving an order where a hash code of any MO belonging to any MOC is larger than a hash code of any MO belonging to any parent MOC of the MOC, or a hash code of any MO belonging to any MOC is smaller than a hash code of any MO belonging to any parent MOC of the MOC.

13. The method of claim 12, wherein said hash table is initialized by:
traversing the MOC tree in an order that, for any MOC node, its ancestor MOC nodes are traversed prior to it;
for each traversed MOC node, allocating a code range based on a cardinal number of the MOC node and cardinal numbers of its all ancestor MOC nodes till a root node; and
dividing a space consisted of the code ranges into hash code ranges with which the slots of the first level slot array are associated.

14. The method of claim 13, wherein obtaining a start hash code and an end hash code comprises:
receiving a retrieval request for retrieving data of a set of managed objects belonging to a given MOC, said retrieval request containing said given MOC's name;
searching the MOC tree for said given MOC to obtain its allocated code range; and
determining the start hash code as the start of the allocated code range, and the end hash code as the end of the allocated code range.

15. The method of claim 13, wherein obtaining a start hash code and an end hash code comprises:
receiving a retrieval request for retrieving data of a set of managed objects belonging to one or more MOCs, the managed objects of said set of managed objects being descendants from a given managed object, said retrieval request containing said given managed object's distinguished name and a set of MOC names which are descendents of the given managed object's MOC; and
for each descendent MOC,
searching the MOC tree for said descendent MOC to obtain its allocated code range;
extracting a hash code range corresponding to descendents of the given managed object from the allocated code range, based on a first hash code generated from the given managed object's distinguished name according to the first hash function; and
determining the start hash code as the start of the extracted hash code range, and the end hash code as the end of the extracted hash code range.

16. The method of claim 10, further comprising:
obtaining a filter condition; and
filtering the searched hash entries with the filter condition.

17. An apparatus for processing data in a hash table, wherein said hash table comprises a first level slot array with a constant number of slots and at least one second level slot array with a variant number of slots, each slot of the first level slot array being associated with a hash code range generated with a first hash function, and each slot of the first level slot array being linked to at most one second level slot array, said apparatus comprising:
a receiving unit, configured to receive data to be processed, said data being represented by a key and value pair;
a first level unit, comprising a first hashing unit configured to generate obtain a first hash code which is generated from the key according to the first hash function, and a first slot determination unit configured to determine a slot of the first level slot array associated with a hash code range to which the first hash code corresponds; and
a second level unit, configured to store said key and value pair into a second level slot array to which the determined slot of the first level slot array is linked.

18. The apparatus of claim 17, wherein the constant number N of slots of the first level slot array is determined based on a maximum possible number of key and value pairs to be put into said hash table and a space factor for the first level slot array.

19. The apparatus of claim 17, wherein slots of the first level slot array are arranged to be associated with a respective hash code range in the order of hash codes generated according to the first hash function.

20. The apparatus of claim 17, wherein said second level unit comprises:
a decision unit, configured to decide whether the second level slot array needs resizing;
a resizing unit, configured to resize the second level slot array in response that the second level slot array needs resizing;
a second slot determination unit, configured to determine a slot of the second level slot array or of the resized second level slot array from said key according to a second hash function; and
a storing unit, configured to store said key and value pair into the determined slot of the second level slot array or of the resized second level slot array as a hash entry.

21. The apparatus of claim 17, wherein
said data includes network management information consisted of a set of managed objects, a managed object belongs to a managed object class, MOC, a set of MOCs is represented by an MOC tree based on parent-child inheritance relationships among the MOCs, the managed object's distinguished name is used as a key, and the managed object's data is a value associated with the key, and
said first hash function is arranged to map a distinguished name of a managed object to a first hash code, preserving an order where a hash code of any MO belonging to any MOC is larger than a hash code of any MO belonging to any parent MOC of the MOC, or a hash code of any MO belonging to any MOC is smaller than a hash code of any MO belonging to any parent MOC of the MOC.

22. The apparatus of claim 21, wherein said hash table is initialized by an initialization unit which is configured to:
traverse the MOC tree in an order that, for any MOC node, its ancestor MOC nodes are traversed prior to it;
for each traversed MOC node, allocate a code range based on a cardinal number of the MOC node and cardinal numbers of its all ancestor MOC nodes till a root node; and
divide a space consisted of the code ranges into hash code ranges with which the slots of the first level slot array are associated.

23. The apparatus of claim 22, wherein said first hash function is arranged to map a distinguished name of a managed object to a first hash code by a hash unit, which comprises:
a parsing unit, configured to parse the managed object's distinguished name into a set of relative distinguished names, RDNs;
an index determination unit, configured to, for each RDN, determine a relative position i of said RDN within a code range of a MOC node to which the RDN belongs; and
a hash code generation unit, configured to generate the first hash code based on the relative position of each RDN.

24. An apparatus for searching data in a range of a hash table, wherein said hash table comprises a first level slot array with a constant number of slots and at least one second level slot array with a variant number of slots, each slot of the first level slot array being associated with a hash code range in the order of hash codes generated with a first hash function, and each slot of the first level slot array being linked to at most one second level slot array, said apparatus comprising:
a parameter obtaining unit, configured to obtain a start hash code and an end hash code which define the range of the hash table;
a range determination unit, configured to determine a slot range of the first level slot array, wherein a start slot of the slot range is associated with a hash code range to which the start hash code corresponds, and an end slot of the slot range is associated with a hash code range to which the end hash code corresponds;
a searching unit, configured to search hash entries in each second level slot array to which each slot within the slot range is linked; and
a result output unit, configured to return searched hash entries.

25. The apparatus of claim 24, wherein said parameter obtaining unit comprises:
a receiving unit, configured to receive a start key and an end key; and
a hashing unit, configured to generate the start hash code from the start key according to the first hash function and the end hash code from the end key according to the first hash function.

26. The apparatus of claim 24, wherein
said data includes network management information consisted of a set of managed objects, a managed object belongs to a managed object class, MOC, a set of MOCs is represented by an MOC tree based on parent-child inheritance relationships among the MOCs, the managed object's distinguished name is used as a key, and the managed object's data is a value associated with the key, and
said first hash function is arranged to map a distinguished name of a managed object to a first hash code, preserving an order where a hash code of any MO belonging to any MOC is larger than a hash code of any MO belonging to any parent MOC of the MOC, or a hash code of any MO belonging to any MOC is smaller than a hash code of any MO belonging to any parent MOC of the MOC.

27. The apparatus of claim 26, wherein said hash table is initialized by an initialization unit which is configured to:
traverse the MOC tree in an order that, for any MOC node, its ancestor MOC nodes are traversed prior to it;
for each traversed MOC node, allocate a code range based on a cardinal number of the MOC node and cardinal numbers of its all ancestor MOC nodes till a root node; and
divide a space consisted of the code ranges into hash code ranges with which the slots of the first level slot array are associated.

28. The apparatus of claim 27, wherein said parameter obtaining unit comprises:
a request receiving unit, configured to receive a retrieval request for retrieving data of a set of managed objects belonging to a given MOC, said retrieval request containing said given MOC's name;
an MOC tree searching unit, configured to search the MOC tree for said given MOC to obtain its allocated code range; and
a start-end determination unit, configured to determine the start hash code as the start of the allocated code range, and the end hash code as the end of the allocated code range.

29. The apparatus of claim 27, wherein said parameter obtaining unit comprises:
a request receiving unit, configured to receive a retrieval request for retrieving data of a set of managed objects belonging to one or more MOCs, the managed objects of said set of managed objects being descendants from a given managed object, said retrieval request containing said given managed object's distinguished name and a set of MOC names which are descendents of the given managed object's MOC;
an MOC tree searching unit, configured to, for each descendent MOC, search the MOC tree for said descendent MOC to obtain its allocated code range;
a range extracting unit, configured to, for each descendent MOC, extract a hash code range corresponding to descendents of the given managed object from the allocated code range, based on a first hash code generated from the given managed object's distinguished name according to the first hash function; and
a start-end determination unit, configured to, for each descendent MOC, determine the start hash code as the start of the extracted hash code range, and the end hash code as the end of the extracted hash code range.

30-33. (canceled)
